(19) United States
(12) Patent Application Publication
(10) Pub. No.: US 2018/0220344 A1
(43) Pub. Date: Aug. 2, 2018

(54) METHOD AND APPARATUS TO ENABLE A 5G NEW RADIO UE TO PERFORM UE-BASED HANDOFF

(71) Applicant: Sharp Laboratories of America, Inc., Camas, WA (US)

(72) Inventor: Kamel M. Shaheen, Camas, WA (US)

(21) Appl. No.: 15/886,158

(22) Filed: Feb. 1, 2018

Related U.S. Application Data
(63) Continuation of application No. PCT/US2018/016117, filed on Jan. 31, 2018.
(60) Provisional application No. 62/453,983, filed on Feb. 2, 2017.

(51) Int. Cl. H04W 36/00; H04W 4/60

(52) U.S. Cl. CPC H04W 36/0083; H04W 4/60

(57) ABSTRACT

A 5G new radio (NR) user equipment (UE) is described. The UE includes a processor and memory in electronic communication with the processor. Instructions stored in the memory are executable to enable or disable a UE-based handoff (HO) feature in the 5G NR UE. The UE-based handoff feature may be enabled using RRC signaling (AS Access). Alternatively, the UE-based handoff feature may be enabled using NAS signaling (i.e., MME initiated). The UE-based handoff feature may be disabled upon leaving NR system/capable cells in handoff from NR to LTE, in cell re-selection to LTE or in transition to NR cell where the UE-based handoff feature is not supported.

### RELATED APPLICATIONS

This application is related to and claims priority from U.S. Provisional Patent Application No. 62/453,983, entitled “METHOD AND APPARATUS TO ENABLE A 5G NEW RADIO UE TO PERFORM UE-BASED HANDOFF,” filed on Feb. 2, 2017, which is hereby incorporated by reference herein, in its entirety.

### TECHNICAL FIELD

The present disclosure relates generally to communication systems. More specifically, the present disclosure relates to method and apparatus to enable a 5G new radio UE to perform UE-based handoff.

### BACKGROUND

Wireless communication devices have become smaller and more powerful in order to meet consumer needs and to improve portability and convenience. Consumers have become dependent upon wireless communication devices and have come to expect reliable service, expanded areas of coverage and increased functionality. A wireless communication system may provide communication for a number of wireless communication devices, each of which may be serviced by a base station. A base station may be a device that communicates with wireless communication devices.

As wireless communication devices have advanced, improvements in communication capacity, speed, flexibility and/or efficiency have been sought. However, improving communication capacity, speed, flexibility and/or efficiency may present certain problems.

For example, wireless communication devices may communicate with one or more devices using a communication structure. However, the communication structure used may only offer limited flexibility and/or efficiency. As illustrated by this discussion, systems and methods that improve communication flexibility and/or efficiency may be beneficial.

### BRIEF DESCRIPTION OF THE DRAWINGS

FIG. 1 is a block diagram illustrating one implementation of one or more base stations (gNBs) and one or more user equipments (UEs) in which systems and methods for UE-based handoff (HO) may be implemented;

FIG. 2 is a call flow diagram illustrating a new cell activation of a UE-based HO feature;

FIG. 3 is a call flow diagram illustrating a ultra-reliable low latency communication (URLLC) new service activation of UE-based HO;

FIG. 4 is a call flow diagram illustrating area activation of a UE-based HO feature using non-access stratum (NAS) signaling;

FIG. 5 is a call flow diagram illustrating de-activation of UE-based HO feature in the case of NR to LTE inter-radio access technology (RAT) HO;

FIG. 6 is a call flow diagram illustrating a UE capability transfer;

FIG. 7 illustrates network (NW) controlled mobility and UE controlled mobility schemes;

FIG. 8 illustrates examples of a NW controlled secondary cell group (SCG) change;

FIGS. 9A and 9B are a call flow diagram illustrating active mode mobility in LTE;

FIG. 10 is a call flow diagram illustrating a baseline HO procedure for new radio (NR);

FIG. 11 is a call flow diagram illustrating conditional handoff execution based on downlink (DL) reference signal (RS) measurements;

FIG. 12 is a call flow diagram illustrating a HO procedure to establish a link at the target gNB after a mobility trigger has occurred;

FIG. 13 is a call flow diagram illustrating a context fetch procedure to establish a link at the target gNB after the mobility trigger has occurred;

FIG. 14 is a diagram illustrating one example of a resource grid for the downlink;

FIG. 15 is a diagram illustrating one example of a resource grid for the uplink;

FIG. 16 shows examples of several numerologies;

FIG. 17 shows examples of subframe structures for the numerologies that are shown in FIG. 16;

FIG. 18 shows examples of slots and sub-slots;

FIG. 19 shows examples of scheduling timelines;

FIG. 20 shows examples of DL control channel monitoring regions;

FIG. 21 shows examples of DL control channel which includes more than one control channel elements;

FIG. 22 shows examples of UL control channel structures;

FIG. 23 is a block diagram illustrating one implementation of a gNB;

FIG. 24 is a block diagram illustrating one implementation of a UE;

FIG. 25 illustrates various components that may be utilized in a UE;

FIG. 26 illustrates various components that may be utilized in a gNB;

FIG. 27 is a block diagram illustrating one implementation of a UE in which systems and methods for UE-based HO may be implemented; and

FIG. 28 is a block diagram illustrating one implementation of a gNB in which systems and methods for UE-based HO may be implemented.

### DETAILED DESCRIPTION

A 5G new radio (NR) user equipment (UE) is described. The UE includes a processor and memory in electronic communication with the processor. Instructions stored in the memory are executable to enable or disable a UE-based handoff (HO) feature in the 5G NR UE.

The UE-based handoff feature may be enabled using RRC signaling (AS Access) during initial access (e.g., a new cell), during HO, power-up, area updates, or any other operation. Alternatively, the UE-based handoff feature may be enabled using RRC signaling (AS Access) during activation of a new service (e.g., URLLC). In yet another alternative, the UE-based handoff feature may be enabled using NAS signaling (i.e., Mobility Management Entity (MME) initiated) during NR 5G attach procedures, during NR 5G Routing Area Updates or during handoff.

The UE may disable the UE-based handoff feature upon leaving NR system/capable cells in handoff from NR to LTE, in cell re-selection to LTE or in transition to NR cell where the UE-based handoff feature is not supported.

New messages and new Information Elements (IEs) in existing UE capability exchange messages may indicate support of NR 5G radio capabilities and the support of UE-based handoff feature. A UE-EUTRA-Capability message may be used in a dual mode LTE UE that supports NR capabilities while operating in LTE mode, the UE-EUTRA-Capability message including an indication (e.g., nr-utraFDD, nr-utraTDDxxx) whether the UE supports 5G NR technology (frequency division duplexing (FDD) or time division duplexing (TDD)), and an indication (e.g., UE-Based-mobility-support-r14) whether the UE supports the UE-based HO feature.

A UE-NRUTRA-Capability message may be used with a multi-mode NR UE. The UE-NRUTRA-Capability message may include one or more capability indications, the capability indications including an indication (e.g., UE-NRUTRA-Capability, nr-utraFDD, nr-utraTDDxxx) whether the UE supports 5G NR technology (FDD or TDDs), and an indication whether the UE supports UE-based HO feature.

Information elements (IEs) in system information block (SIB) 3, SIB4, SIB5, or SIB 6 may include 5G NR related information to existing LTE messages.

The UE-based HO may be triggered based on preconfigured information (stored in a Subscriber Identity Module (SIM)) and/or information received over the air and stored in the device memory or SIM-card.

The UE-based HO may be triggered according to events with specific 5G NR IEs. The UE may receive UE-based HO trigger events and parameters over the air from a 5G NR base station.

The UE may use different combinations of capability reporting, enablement (disablement) by the network, and IEs provided by the network and/or stored in the UE (pre-configured or previously received) to trigger UE-based HO.

A RRC message may be used to instruct the 5G NR UE with the rules and directives on how to make a handoff decision to a selected target cell.

The UE may use broadcast information (for example: using SIB1, SIB2, . . . , SIB8) to activate the UE-based handoff. The broadcast information may include an activation flag, a list of neighboring cells with their priorities and system configurations.

A 5G new radio (NR) Base Station (gNB) is also described. The gNB includes a processor and memory in electronic communication with the processor. Instructions stored in the memory are executable to enable or disable a UE-based handoff (HO) feature in a 5G NR UE.

The 3rd Generation Partnership Project, also referred to as “3GPP,” is a collaboration agreement that aims to define globally applicable technical specifications and technical reports for third and fourth generation wireless communication systems. The 3GPP may define specifications for next generation mobile networks, systems and devices.

3GPP Long Term Evolution (LTE) is the name given to a project to improve the Universal Mobile Telecommunications System (UMTS) mobile phone or device standard to cope with future requirements. In one aspect, UMTS has been modified to provide support and specification for the Evolved Universal Terrestrial Radio Access (E-UTRA) and Evolved Universal Terrestrial Radio Access Network (E-UTRAN).

At least some aspects of the systems and methods disclosed herein may be described in relation to the 3GPP LTE, LTE-Advanced (LTE-A) and other standards (e.g., 3GPP Releases 8, 9, 10, 11 and/or 12). However, the scope of the present disclosure should not be limited in this regard. At least some aspects of the systems and methods disclosed herein may be utilized in other types of wireless communication systems.

A wireless communication device may be an electronic device used to communicate voice and/or data to a base station, which in turn may communicate with a network of devices (e.g., public switched telephone network (PSTN), the Internet, etc.). In describing systems and methods herein, a wireless communication device may alternatively be referred to as a mobile station, a UE, an access terminal, a subscriber station, a mobile terminal, a remote station, a user terminal, a terminal, a subscriber unit, a mobile device, etc. Examples of wireless communication devices include cellular phones, smart phones, personal digital assistants (PDAs), laptop computers, netbooks, e-readers, wireless modems, etc. In 3GPP specifications, a wireless communication device is typically referred to as a UE. However, as the scope of the present disclosure should not be limited to the 3GPP standards, the terms “UE” and “wireless communication device” may be used interchangeably herein to mean the more general term “wireless communication device.” A UE may also be more generally referred to as a terminal device.

In 3GPP specifications, a base station is typically referred to as a Node B, an evolved Node B (eNB), a gNB, a home enhanced or evolved Node B (HeNB) or some other similar terminology. As the scope of the disclosure should not be limited to 3GPP standards, the terms “base station,” “Node B,” “eNB,” and “HeNB” may be used interchangeably herein to mean the more general term “base station.” Furthermore, the term “base station” may be used to denote an access point. An access point may be an electronic device that provides access to a network (e.g., Local Area Network (LAN), the Internet, etc.) for wireless communication devices. The term “communication device” may be used to denote both a wireless communication device and/or a base station. An eNB or gNB may also be more generally referred to as a base station device.

It should be noted that as used herein, a “cell” may be any communication channel that is specified by standardization or regulatory bodies to be used for International Mobile Telecommunications-Advanced (IMT-Advanced) and all of it or a subset of it may be adopted by 3GPP as licensed bands (e.g., frequency bands) to be used for communication between an eNB and a UE. It should also be noted that in E-UTRA and E-UTRAN overall description, as used herein, a “cell” may be defined as “combination of downlink and optionally uplink resources.” The linking between the carrier frequency of the downlink resources and the carrier frequency of the uplink resources may be indicated in the system information transmitted on the downlink resources.

“Configured cells” are those cells of which the UE is aware and is allowed by an eNB to transmit or receive information. “Configured cell(s)” may be serving cell(s). The UE may receive system information and perform the required measurements on all configured cells. “Configured cell(s)” for a radio connection may include a primary cell and/or no, one, or more secondary cell(s). “Activated cells” are those configured cells on which the UE is transmitting and receiving. That is, activated cells are those cells for which the UE monitors the physical downlink control channel (PDCCH) and in the case of a downlink transmission, those cells for which the UE decodes a physical downlink shared channel (PDSCH). “Deactivated cells” are those configured cells that the UE is not monitoring the transmission PDCCH. It should be noted that a “cell” may be described in terms of differing dimensions. For example, a “cell” may have temporal, spatial (e.g., geographical) and frequency characteristics.

Fifth generation (5G) cellular communications (also referred to as “New Radio”, “New Radio Access Technology” or “NR” by 3GPP) envisions the use of time/frequency/space resources to allow for enhanced mobile broadband (eMBB) communication and ultra-reliable low latency communication (URLLC) services, as well as massive machine type communication (mMTC) like services. In order for the services to use the time/frequency/space medium efficiently it would be useful to be able to flexibly schedule services on the medium so that the medium may be used as effectively as possible, given the conflicting needs of URLLC, eMBB, and mMTC. An NR base station may be referred to as a gNB. A gNB may also be more generally referred to as a base station device.

The systems and methods described herein provide a mechanism for the 5G NR UE to inform the network of its capability to support and perform a UE-based handoff (HO) process. As used herein “handoff” may also be referred to as handover. Also, the described systems and methods provide the network with the possibility of control over decisions whether to enable individual UEs to use that capability in case of certain cells or certain service activation. The described systems and methods also allow for the NR cell to send a broadcast to enable all NR capable UEs to activate their UE-based HO feature.

In another implementation, the UE may perform UE-based handoff using existing cell selection/reselection information and procedures while in connected mode. The UE may use pre-configured rules stored in its memory to make handoff decisions based on various conditions and events as defined in 3GPP (e.g., TS36.331, TS36.304, TS36.113). The new information elements (IE) would be those related to 5G New Radio in SIB 1-8.

The procedures will also allow the network control over disabling the feature for or in certain UEs and/or cells in case of handoff, new services, cell reselection, termination of a session, etc. The described systems and methods include message formats for UE capabilities indications, both in Access Stratum (AS) and Non-Access Stratum (NAS).

Various examples of the systems and methods disclosed herein are now described with reference to the Figures, where like reference numbers may indicate functionally similar elements. The systems and methods as generally described and illustrated in the Figures herein could be arranged and designed in a wide variety of different implementations. Thus, the following more detailed description of several implementations, as represented in the Figures, is not intended to limit scope, as claimed, but is merely representative of the systems and methods.

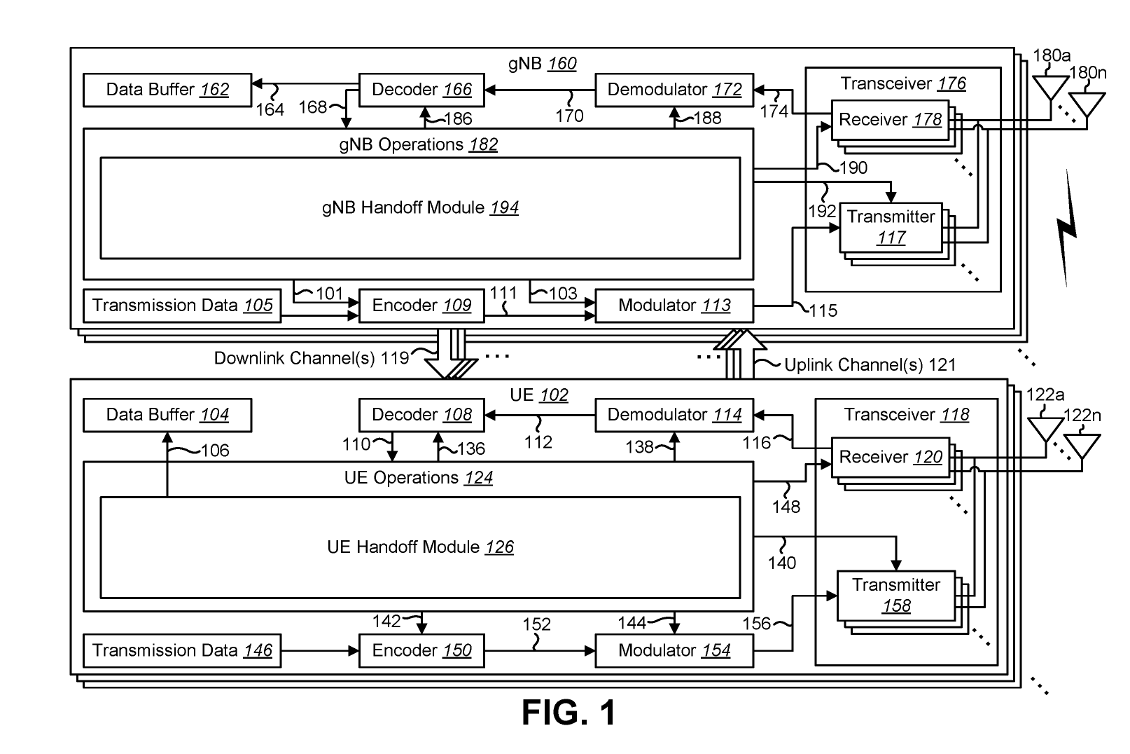

FIG. 1 is a block diagram illustrating one implementation of one or more gNBs 160 and one or more UEs 102 in which systems and methods for UE-based handoff may be implemented. The one or more UEs 102 communicate with one or more gNBs 160 using one or more physical antennas 122a-n. For example, a UE 102 transmits electromagnetic signals to the gNB 160 and receives electromagnetic signals from the gNB 160 using the one or more physical antennas 122a-n. The gNB 160 communicates with the UE 102 using one or more physical antennas 180a-n.

The UE 102 and the gNB 160 may use one or more channels and/or one or more signals 119, 121 to communicate with each other. For example, the UE 102 may transmit information or data to the gNB 160 using one or more uplink channels 121. Examples of uplink channels 121 include a physical shared channel (e.g., PUSCH (Physical Uplink Shared Channel)), and/or a physical control channel (e.g., PUCCH (Physical Uplink Control Channel)), etc. The one or more gNBs 160 may also transmit information or data to the one or more UEs 102 using one or more downlink channels 119, for instance. Examples of downlink channels 119 physical shared channel (e.g., PDSCH (Physical Downlink Shared Channel), and/or a physical control channel (PDCCH (Physical Downlink Control Channel)), etc. Other kinds of channels and/or signals may be used.

Each of the one or more UEs 102 may include one or more transceivers 118, one or more demodulators 114, one or more decoders 108, one or more encoders 150, one or more modulators 154, a data buffer 104 and a UE operations module 124. For example, one or more reception and/or transmission paths may be implemented in the UE 102. For convenience, only a single transceiver 118, decoder 108, demodulator 114, encoder 150 and modulator 154 are illustrated in the UE 102, though multiple parallel elements (e.g., transceivers 118, decoders 108, demodulators 114, encoders 150 and modulators 154) may be implemented.

The transceiver 118 may include one or more receivers 120 and one or more transmitters 158. The one or more receivers 120 may receive signals from the gNB 160 using one or more antennas 122a-n. For example, the receiver 120 may receive and downconvert signals to produce one or more received signals 116. The one or more received signals 116 may be provided to a demodulator 114. The one or more transmitters 158 may transmit signals to the gNB 160 using one or more physical antennas 122a-n. For example, the one or more transmitters 158 may upconvert and transmit one or more modulated signals 156.

The demodulator 114 may demodulate the one or more received signals 116 to produce one or more demodulated signals 112. The one or more demodulated signals 112 may be provided to the decoder 108. The UE 102 may use the decoder 108 to decode signals. The decoder 108 may produce decoded signals 110, which may include a UE-decoded signal 106 (also referred to as a first UE-decoded signal 106). For example, the first UE-decoded signal 106 may comprise received payload data, which may be stored in a data buffer 104. Another signal included in the decoded signals 110 (also referred to as a second UE-decoded signal 110) may comprise overhead data and/or control data. For example, the second UE-decoded signal 110 may provide data that may be used by the UE operations module 124 to perform one or more operations.

In general, the UE operations module 124 may enable the UE 102 to communicate with the one or more gNBs 160. The UE operations module 124 may include one or more of a UE handoff module 126.

The UE handoff module 126 may inform the network of its capability to support/perform UE-based handoff process. The described systems and methods provide the network with the possibility of control over decisions whether to enable individual UEs 102 to use that capability in case of certain cells or certain service activation. The described systems and methods also allow for the NR cell to send a broadcast to enable all NR Capable UEs to activate their UE-based HO feature.

In another aspect, the UE handoff module 126 may perform UE-based handoff using existing cell selection/reselection information and procedures while in connected mode. The UE 102 may use pre-configured rules stored in its memory to make handoff decisions based on various conditions and Events as defined in 3GPP TS36.331, TS36.304, TS36.113. The new information elements (IE) would be those related to 5G New Radio in SIB 1-8.

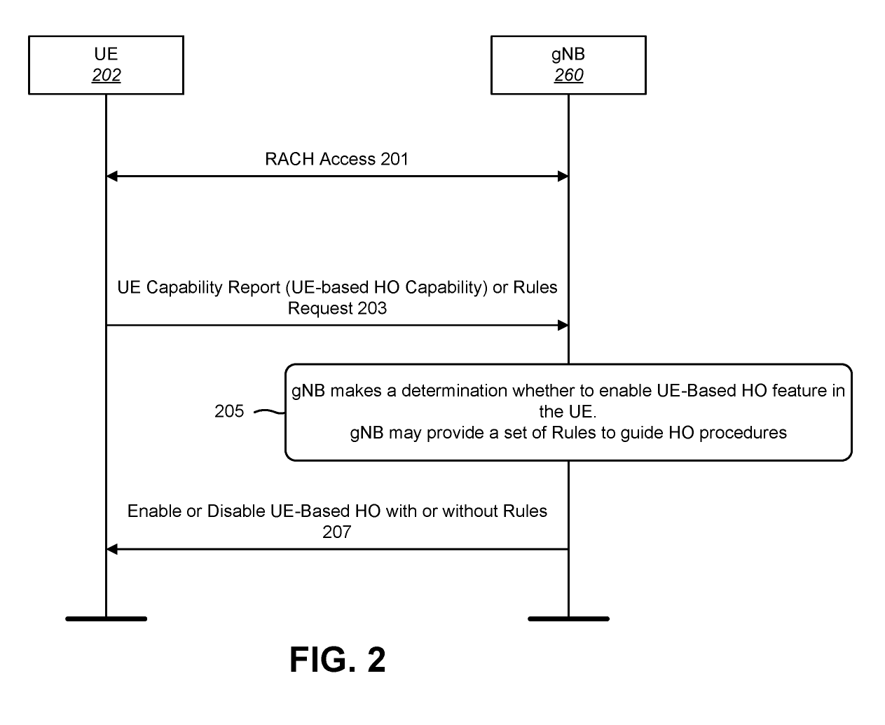

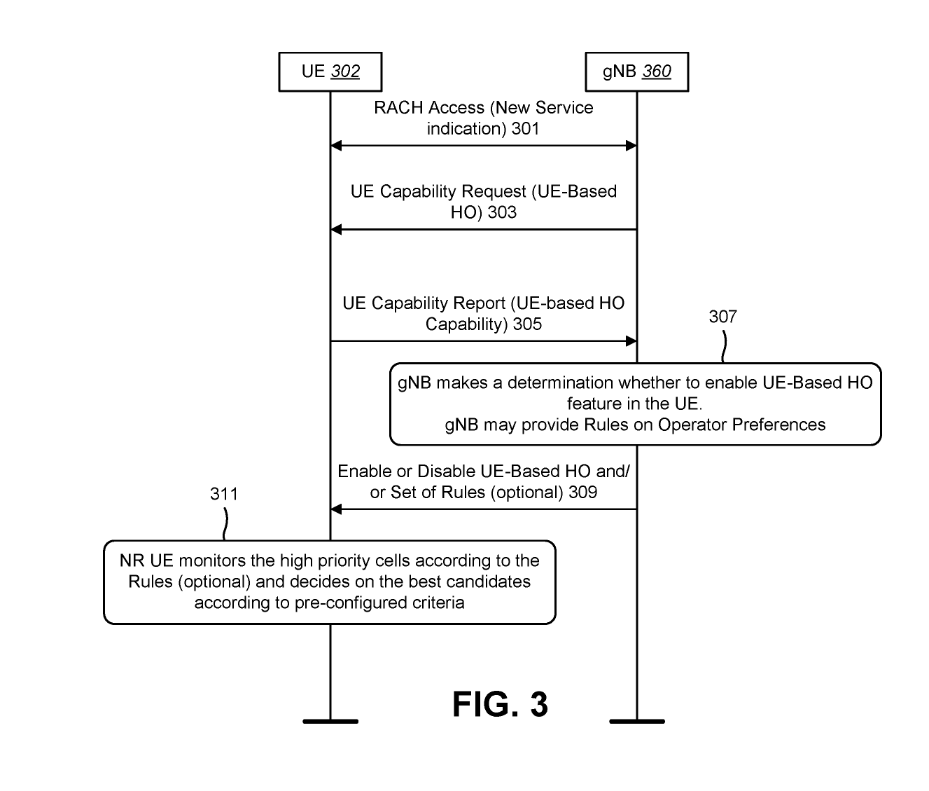

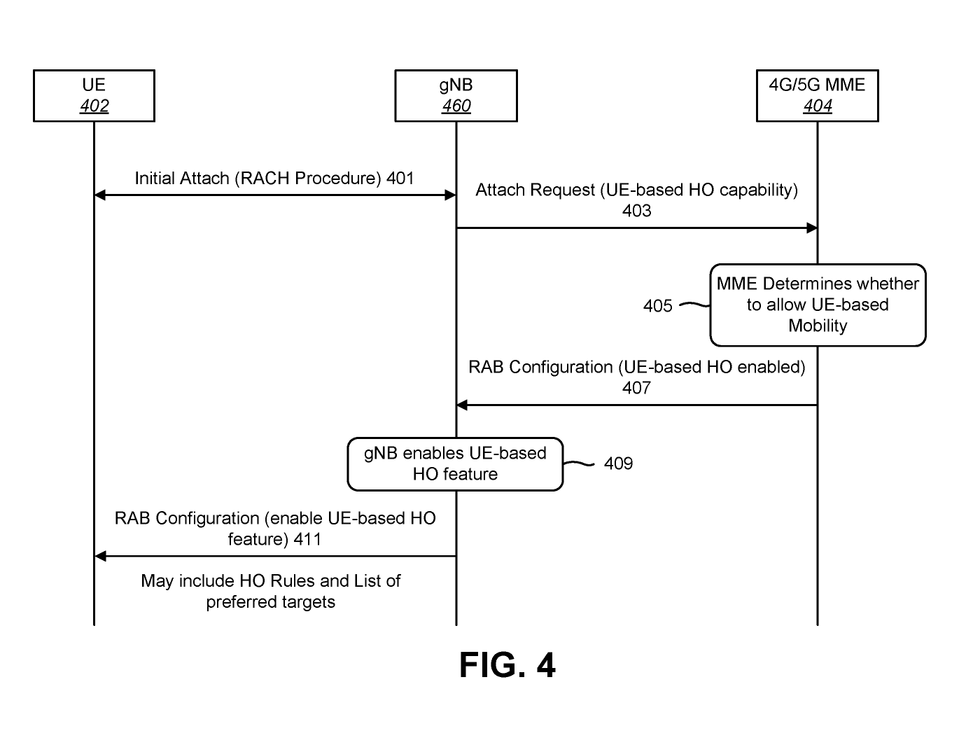

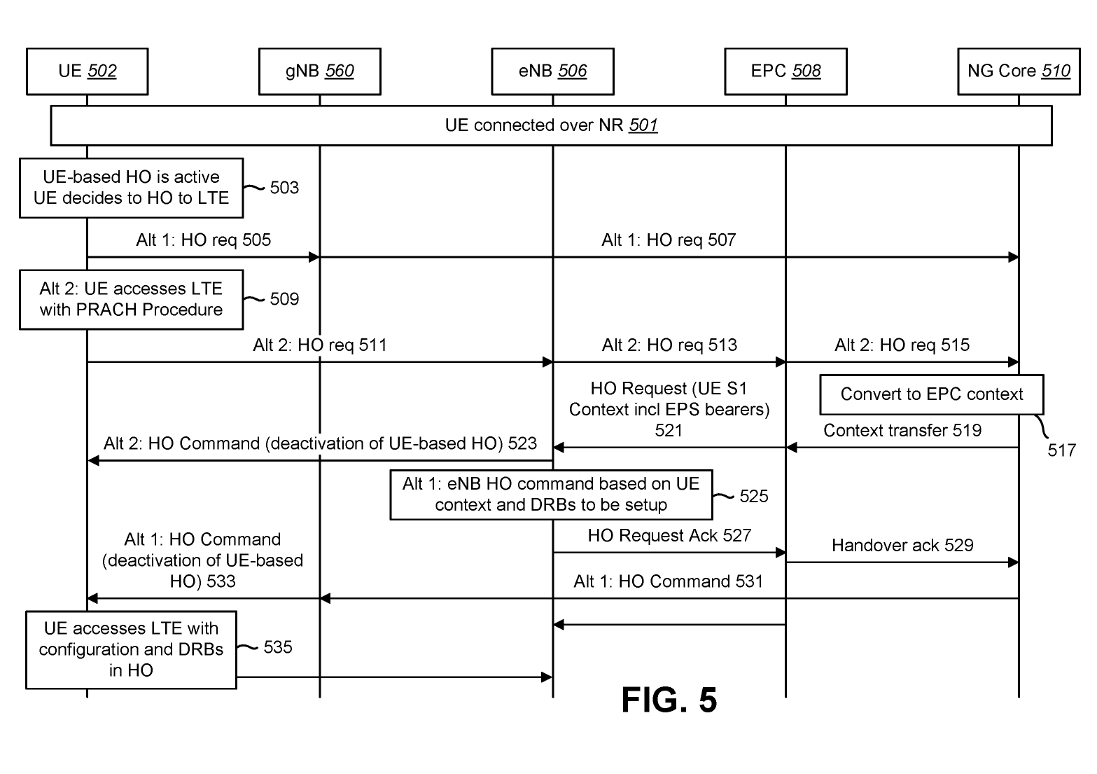

The procedures described herein will also allow the network control over disabling the feature for or in certain UEs and/or cells in case of handoff, new services, cell reselection, termination of a session, etc. The disclosure includes message formats for UE capabilities indications, both in AS and NAS. An example of new cell activation of UE-based HO feature is described in connection with FIG. 2. An example of URLLC new service activation of UE-based HO is described in connection with FIG. 3. An example of area activation of UE-based HO feature using NAS signaling is described in connection with FIG. 4. An example of de-activation of UE-based HO feature in the case of NR to LTE inter-RAT HO is described in connection with FIG. 5.

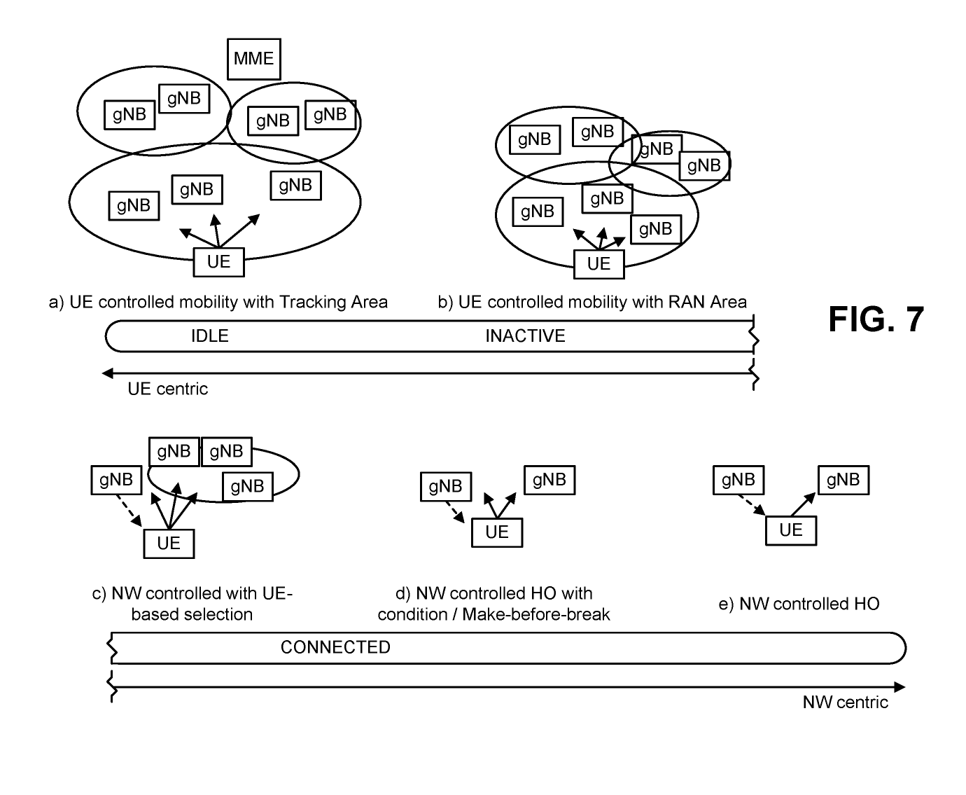

In NR, RRC_INACTIVE is introduced, which uses Radio Access Network (RAN) area level UE controlled mobility. On the other hand, even in RRC_CONNECTED, some kind of UE controlled mobility is discussed as shown in FIGS. 7 (c) and (d). In a legacy system, normal handoff operation is based on HO command which include a target cell identity and random access parameters to access the target cell in response to receive the HO command. In addition to the normal handoff operation, UE determination of a handoff trigger based on a configured condition after HO command may be supported. A make-before-break type of HO may be considered. These schemes allow the UE 102 to determine an exact timing of access to the target cell while only one target cell is assumed. An example of NW controlled mobility and UE controlled mobility schemes is provided in FIG. 7.

In addition, further relaxing network control may be considered. Since a context fetch procedure will be available in NR, UE-based target cell determination may have some benefit to relax network based mobility. However, if the UE 102 is allowed to select the target cell among candidate cells, a HO command may need to include system information corresponding to candidate cells. Alternatively, it may be a possible solution that the UE 102 acquires a minimum SI based on cell selection/reselection procedure. It may require additional receiver or gap configuration to get another cell's system information.

To support UE-based determination of a target cell or access timing to the target, data forwarding timing may also be taken into consideration. In a normal handoff procedure, data forwarding starts at the HO command. If context fetch is used, it is possible to start data forwarding at the timing of context fetch. In this procedure, some data packet in a source cell would be lost and data delivery at a target cell would be delayed, but the source cell does not need to forward data until the UE 102 accesses to the target.

In normal handoff, at a preparation phase, a source gNB 160 negotiates with a target gNB 160 and the target gNB 160 performs admission control before HO command is delivered to the UE 102. If the network supports UE-based determination of a target cell, admission control has to be done at access to the target by acquiring system information directly from the target. This would have some benefit to reduce negotiations between gNBs 160.

A normal HO command complete message does not need to include source cell related information because the target cell is prepared and knows the source cell. However, resuming complete/Re-establishment request needs to include UE identity of a source cell, a source cell identity, source gNB identity in the message because the target cell does not know the source cell and the target cell does not have a UE context. To support UE-based determination of a target cell, a type of resuming complete/Re-establishment request message may be used.

Therefore, a UE-based determination of a target cell or access timing to the target may be defined. In a first approach, the following aspects may be implemented for HO enhancement: (1) NW based target cell determination or UE-based target cell determination; (2) target cell access upon HO command or upon UE determination; (3) SI delivery including Random Access Channel (RACH) parameters in HO command or Direct minimum SI reading; (4) data forwarding before access to the target cell or after access to the target cell; (5) admission control before access to the target cell or at SIB reading on the target cell; and (6) a HO complete type of message or re-establishment type of message.

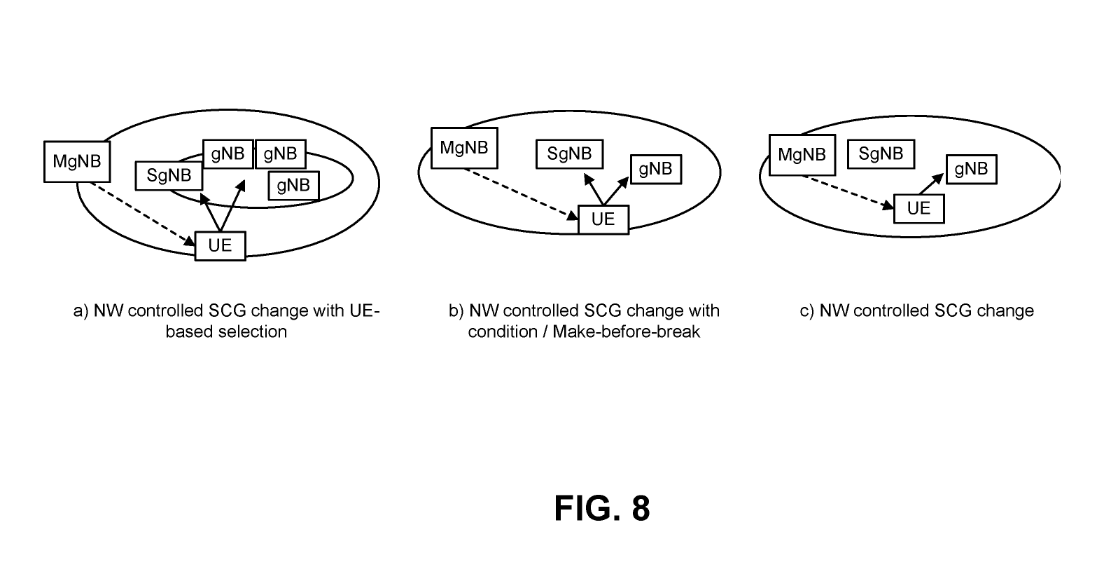

The above aspects can also be applied to a secondary cell group (SCG) change operation in dual connectivity scenario. Relaxing network control for SCG mobility will be efficient. Especially for small cell deployment and multiple TRP deployment, UE controlled mobility will have benefit on interruption time and overhead of measurement. Examples of a NW controlled SCG change are provided in FIG. 8.

In another approach, both PCell and PSCell should be considered on the above aspects.

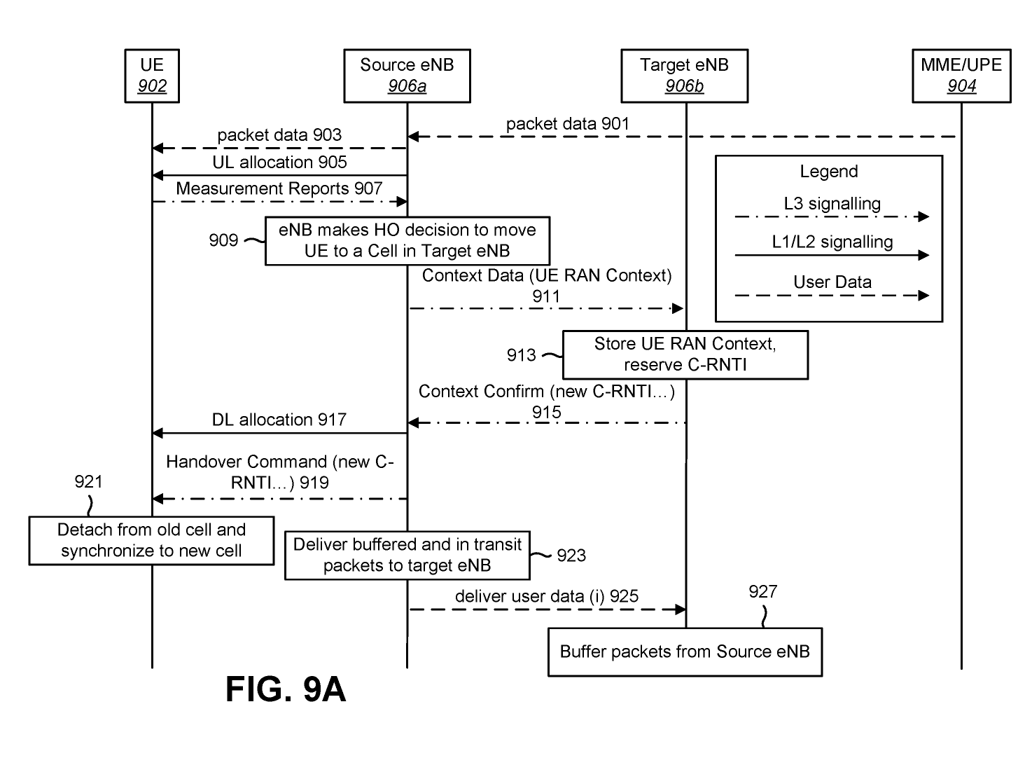

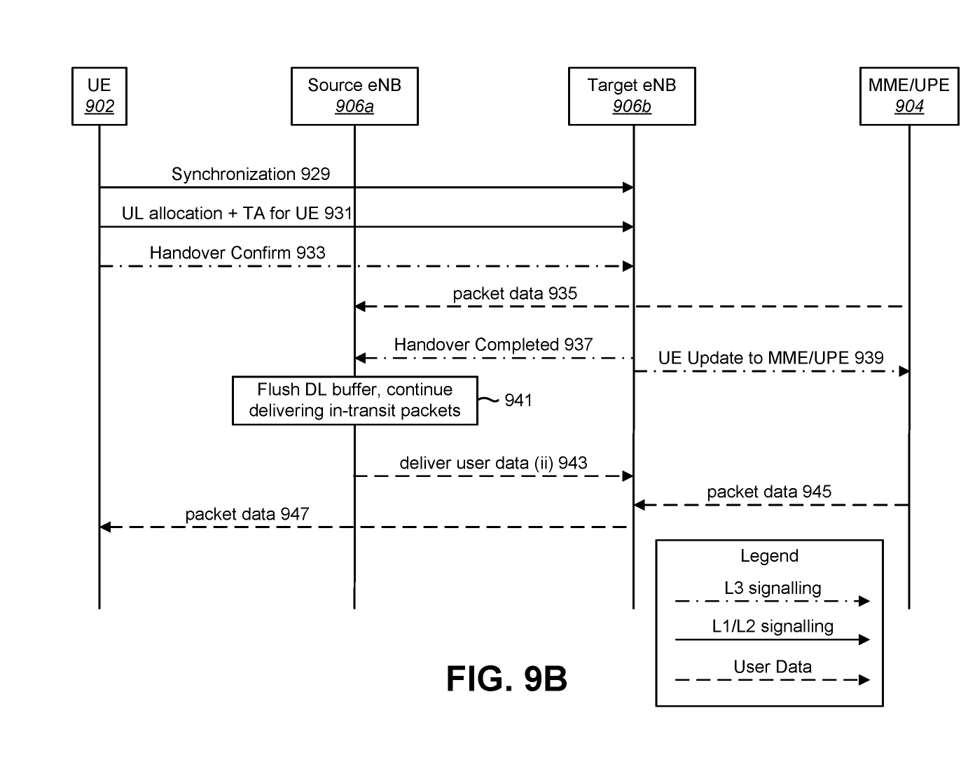

The LTE HO procedure is described herein. In LTE, a UE 102 in RRC CONNECTED state is configured with event based report triggering criteria. Measurements are configured to be done primarily based on Cell-specific Reference Signal (CRSs), transmitted all over the carrier frequency and in all subframes. Based on Physical Cell Identifiers (PCIs), the UE 102 is able to derive the CRS of serving and neighbor cells. There is a one-to-one mapping between the PCI and CRSs. An example of an LTE HO procedure is described in connection with FIGS. 9A-9B.

Once a triggering criterion has been met, the UE 102 sends a measurement report to the Source eNB via RRC. The measurement reporting parameters provided by the network aim to minimize both ping-pong as well as handoff failures. For intra-frequency mobility this is typically achieved by configuring an A3 measurement event so that a report is triggered when a neighbor cell is found to be a few decibels (dB) better than the serving cell. Due to measurement errors in bad radio conditions and due to the necessary filtering, the actual difference in signal strength may be worse than anticipated by the configured event threshold. A consequence of this is that many measurement reports and the subsequent mobility related RRC signaling are exchanged in challenging radio conditions and are hence error prone. In summary, LTE handoff involves RRC signaling over degrading radio links (from the source cell to the UE 102) which may cause undesired latency and high failure probability.

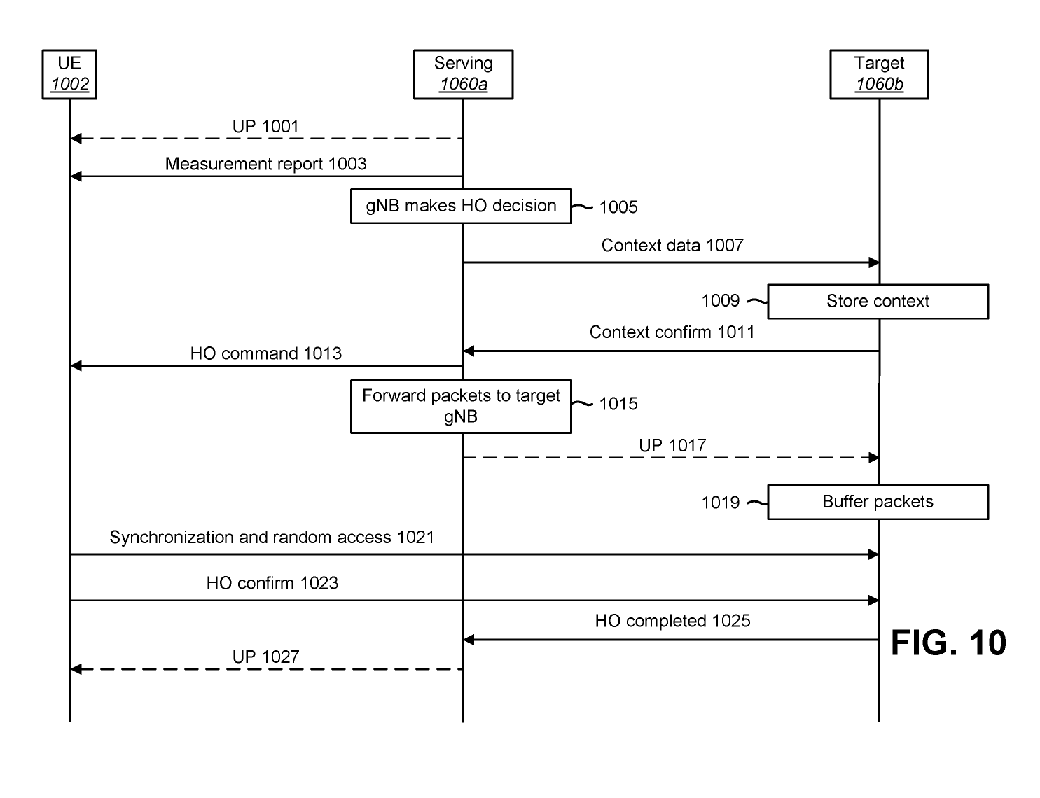

The baseline NR HO procedure is also described herein. It is natural to design the baseline NR HO procedure based on the LTE procedure described above regardless of how the different procedures will need to be adjusted to the fact that downlink (DL) mobility reference signals (MRSs) need to be beamformed and carry a beam ID and multiple of these MRSs would be associated to the source cell while other MRSs would be associated to the target cell. This baseline procedure is shown in FIG. 10.

Even though the baseline HO procedure is very similar to the LTE procedure on a high level, the details of several steps will differ. This discussion focuses on the handoff execution (i.e., steps 4 to 6 in FIG. 10). The measurement report contents will also need to be updated to support beam based mobility.

The assumption here is that the UE 102 should be able to map an NR cell ID to a group of beamformed mobility RSs with beam IDs associated to it by some of the solutions being discussed. For example, by dedicated signaling, the UE 102 knows that a given range of MRSs belong to a given cell and/or a broadcasted mobility RS encodes a beam ID that also encodes a cell ID. Therefore, regardless of what the final solution is a handoff command containing a cell ID should enable the UE 102 to identify a single beam and/or multiple beams associated to a target cell.

The different alternatives for the handoff execution can be classified by the information contained in the handoff command and the corresponding synchronization and random access procedure. Different alternatives are listed in Table 1.

TABLE 1

| | 4. HO command contents | 5. Sync and random access |
|---|---|---|
| Alternative 1 | Cell identity only. | UE autonomously selects the strongest |
| | Note that the cell identity can | beam associated to the indicated cell |
| | be signaled either explicitly | identity. |
| | or implicitly via e.g. MRS | UE reads the random access parameters |
| | configuration (see [XX] for | from system information and uses those |
| | more details) | for the initial access on the selected |
| | | beam |
| Alternative 2 | Cell identity + PRACH | UE autonomously selects any beam |
| | configuration | associated to the indicated cell identity. |
| | Multiple PRACH | UE uses the random access parameters |
| | configurations may be | from the HO command and uses those |
| | provided to enable different | for the initial access on the selected |
| | Random Access (RA) | beam |
| | parameters for different | |
| | beams or beam groups | |
| Alternative 3 | Cell identity + PRACH | UE autonomously selects a beam from |
| | configuration + list of | the list of provided beam IDs associated |
| | allowed beams | to the indicated cell identity. |
| | Multiple PRACH | UE uses the random access parameters |
| | configurations may be | from the HO command and uses those |
| | provided to enable different | for the initial access on the selected |
| | RA parameters for different | beam |
| | beams or beam groups | |
| Alternative 4 | Cell identity + PRACH | UE synchronizes to the beam ID |
| | configuration + indication of | provided in HO command with |
| | allowed beam | provided cell identity. |
| | | UE uses the random access parameters |
| | | from the HO command and uses those |
| | | for the initial access |
| Alternative 5 | Cell identity + PRACH | UE autonomously selects a beam from |
| | configuration + list of | the list of provided beam IDs with |
| | allowed beams + mapping | correct cell identity. |
| | between beams and a RA | UE uses the random access parameters |
| | preamble | from the HO command and uses the |
| | | preamble corresponding to the selected |
| | | beam to indicate to the network which |
| | | beam it selected. |

In alternative 1, the UE 102 receives a handoff command which contains a target cell identity. This target cell identify may be explicitly signaled, or may be derived from other parameters, such as configuration of mobility reference signals. Upon receiving the handoff command, the UE 102 will autonomously find a beam with a correct cell identity, read the corresponding system information matching the beam and cell, and make a random access using contention based random access procedure. This has the benefit of requiring the least signaling and network configuration but may result in a handoff failure if there are other UEs competing for the random access at the same time.

In alternative 2, the UE 102 receives a handoff command which contains a target cell identity and a random access configuration. This target cell identify may be explicitly signaled, or may be derived from other parameters, such as configuration of mobility reference signals. Upon receiving the handoff command, the UE 102 will autonomously find a beam with a correct cell identity, and make a random access using the random access configuration provided in the handoff command. This has the benefit of allowing network to provide a dedicated handoff configuration for the UE 102, but requires some additional configuration and signaling.

In alternative 3, the UE 102 receives a handoff command which contains a target cell identity, a random access configuration and a list of allowed beams. This target cell identify may be explicitly signaled, or may be derived from other parameters, such as configuration of mobility reference signals. The list of beams may also be explicitly signaled, or may be derived from other parameters such as configuration of the mobility reference signals. Upon receiving the handoff command, the UE 102 will select a beam with both correct cell identity and an allowed beam identify. It will then make a random access using the random access configuration provided in the handoff command. This has the benefit of allowing network to provide a dedicated handoff configuration for the UE 102, and limiting the number of possible beams the UE 102 may end it, but requires additional configuration and signaling. The UE 102 may also end up in a non-optimal beam.

In alternative 4, the UE 102 receives a handoff command, which contains a target cell identity, a random access configuration and a target beam identity. This target cell identify may be explicitly signaled, or may be derived from other parameters, such as configuration of mobility reference signals. The target beam identity may also be explicitly signaled, or may be derived from other parameters such as configuration of the mobility reference signals. Upon receiving the handoff command, the UE 102 will search for a beam with both correct cell identity and correct beam identify. It will then make a random access using the random access configuration provided in the handoff command. This has the benefit of allowing network to provide a dedicated handoff configuration for the UE 102, and explicitly assigning the UE 102 to a particular beam, but requires additional configuration and signaling and may result in the UE 102 ending up in a non-optimal beam.

In alternative 5, the UE 102 receives a handoff command which contains a target cell identity, a random access configuration, a list of allowed beams and a mapping of a random preamble (or some other part of access configuration) to each beam identifier. The target cell identify may be explicitly signaled, or may be derived from other parameters, such as configuration of mobility reference signals. The list of beams may also be explicitly signaled, or may be derived from other parameters such as configuration of the mobility reference signals.

Upon receiving the handoff command, the UE 102 will select a beam with both correct cell identity and an allowed beam identify. It will then make a random access using the random access configuration provided in the handoff command, and set the random access preamble value to the value corresponding to the selected beam identifier. This has the benefit of allowing network to provide a dedicated handoff configuration for the UE 102, limiting the number of possible beams the UE 102 may end it and allowing network to immediately detect which beam the UE 102 has selected, but again requires additional configuration and signaling. The UE 102 may also end up in a non-optimal beam.

The high level baseline procedure may be adopted as the working assumption for NR. Different alternatives for the hand-over execution may be studied.

The NR HO procedure challenges are also described herein. In a beam-based system like NR, and especially in higher frequency bands, the serving radio link to the UE 102 may become impaired much more rapidly than in conventional LTE deployments. As the UE 102 is moving out of the current serving beam coverage area, it may not be possible to conduct RRC signaling via the serving node to complete the HO procedure. It should be noted that in some NR deployments and scenarios, the probability of HO failure could increase due to the dependency on the RRC signaling transmissions over the source node at a time when the UE 102 has already moved into the coverage area of the target cell.

An early HO command may be used to improve HO robustness. To avoid the undesired dependence on the serving radio link upon the time (and radio conditions) where the UE 102 should execute the handoff, NR should offer the possibility to provide that RRC signaling to the UE 102 earlier. To achieve this, it should be possible to associate the HO command with a condition. As soon as the condition is fulfilled, the UE 102 may execute the handoff in accordance with the provided handoff command.

In summary, NR should offer the possibility to associate the HO command (e.g., RRCConnectionReconfiguration with mobilityControlInfo) with a condition. As soon as the UE 102 determines the condition to be fulfilled, it may execute the handoff in accordance with the handoff command.

Such a condition could, for example, be that the quality of the mobility RS (MRS) of the target cell or beam becomes X dB stronger than the mobility RS (MRS) of the serving cell. The threshold used in a preceding measurement reporting event should then be chosen lower than the one in the handoff execution condition. This allows the serving cell to prepare the handoff upon reception of an early measurement report and to provide the RRCConnectionReconfiguration with mobilityControlInfo at a time when the radio link to the UE 102 is still stable. The execution of the handoff is done at a later point in time (and threshold) that is considered optimal for the handoff execution.

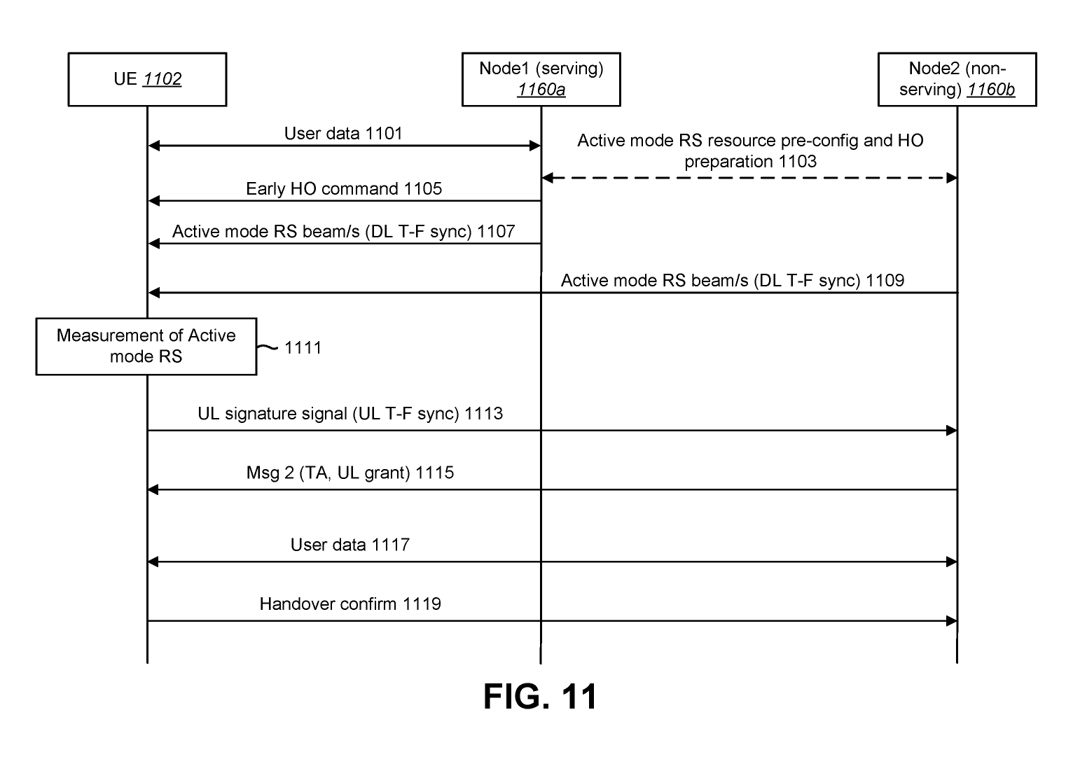

An example of a conditional handoff execution based on DL RS measurements with just a serving and a target gNB is described in connection with FIG. 11. In practice there may often be many cells or beams that the UE 102 reported as possible candidates based on its preceding Radio Resource Management (RRM) measurements. The radio access network (RAN) should then have the freedom to issue conditional handoff for several of those candidate.

The RRCConnectionReconfiguration for each of those candidates may differ, for example, in terms of the HO execution condition (e.g., RS to measure and threshold to exceed) as well as in terms of the RA preamble (denoted Uplink Signature Signal in FIG. 11) to be sent when a condition is met. It may, for example, increase the HO success rate if the UE 102 indicates by means of different RA preambles, which of the candidate target beams it selected (i.e., which beam fulfilled the HO execution condition).

This basic structure may be combined with other HO-enhancements. For example, the RRCConnectionReconfiguration for the early HO command could, for instance, also comprise a configuration for sending UL reference signals (similar to RA preambles) that both the serving as well as the neighbor nodes attempt to receive. The network could determine the most suitable cell based on the observed uplink signals and issue a downlink reference signal upon which the UE 102 executes the pre-conditioned HO command.

A UE 102 aiming to support URLLC with extremely short HO interruption requirements could be configured to maintain the data exchange with the source node while establishing the data exchange with the target. As was discussed with the LTE mobility enhancement, this may require additional Hardware Elements in the UE 102 and may, therefore, likely not be supported by all UEs 102.

To summarize, LTE handoff involves RRC signaling over degrading radio links (from the source cell to the UE 102) which may cause undesired latency and high failure probability. In some NR deployments and scenarios, the probability of HO failure could increase due to the dependency on the RRC signaling transmissions over the source node at a time when the UE 102 has already moved into the coverage area of the target cell.

Based on these observations, the following may be implemented. The baseline procedure in FIG. 10 may be adopted as the NR handoff procedure. Different alternatives may be studied for the hand-over execution. NR may offer the possibility to associate the HO command (RRCConnectionReconfiguration with mobilityControlInfo) with a condition. As soon as the UE 102 determines the condition to be fulfilled, it may execute the handoff in accordance with the handoff command.

Procedures to enable a 5G New Radio UE to perform UE-based handoff are explained in connection with FIGS. 2-4. FIG. 2 illustrates an example of new cell activation of UE-based HO feature. FIG. 3 illustrates an example of ultra-reliable low latency communication (URLLC) new service activation of a UE-based HO. FIG. 4 illustrates an example of area activation of a UE-based HO feature using NAS signaling. An example of de-activation of a UE-based handoff feature in the case of NR-to-LTE inter-RAT HO is described in connection with FIG. 5.

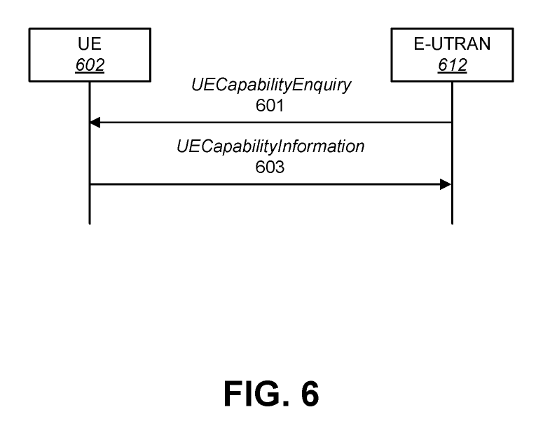

Possible changes to TS 36.331 for Dual mode capable UEs (i.e., Capable of support of LTE E-UTRAN and 5G NR) are described herein. A UE capability transfer is described in connection with FIG. 6. The purpose of this procedure is to transfer UE radio access capability information from the UE to E-UTRAN. If the UE 102 has changed its E-UTRAN radio access capabilities, the UE 102 may request higher layers to initiate the necessary NAS procedures that would result in the update of UE radio access capabilities using a new RRC connection. It should be noted that a change of the UE's GERAN UE radio capabilities in RRC_IDLE is supported by use of Tracking Area Update.

The E-UTRAN initiates the procedure to a UE in RRC_CONNECTED when it needs (additional) UE radio access capability information. Reception of the UECapabilityEnquiry by the UE 102 is also described herein. The UE shall for NB-IoT, set the contents of UECapabdityInformation message as follows: include the UE Radio Access Capability Parameters within the ue-Capability-Container. Otherwise, the UE 102 may set the contents of UECapabdityInformation message as follows. If the ue-CapabilityRequest includes eutra, the UE 102 may include the UE-EUTRA-Capability within a ue-CapabilityRAT-Container and with the rat-Type set to eutra.

If the ue-CapabilityRequest includes nr-utra, then the UE 102 may include the UE-NRUTRA-Capability within a ue-CapabilityRAT-Container and with the rat-Type set to nr-utra. The UE 102 may determine whether UE-based HO is supported by the UE 102 include ue-HOInfo and set the fields accordingly.

If the UE 102 is a category 0 or M1 UE, or supports any UE capability information in ue-RadioPagingInfo, according to TS 36.306, then the UE 102 may include ue-RadioPagingInfo and may set the fields according to TS 36.306.

If the ue-CapabilityRequest includes geran-cs and if the UE 102 supports GERAN circuit switches (CS) domain, then the UE 102 may include the UE radio access capabilities for GERAN CS within a ue-CapabilityRAT-Container and with the rat-Type set to geran-cs.

If the ue-CapabilityRequest includes geran-ps and if the UE 102 supports GERAN packet switched (PS) domain, then the UE 102 may include the UE radio access capabilities for GERAN PS within a ue-CapabilityRAT-Container and with the rat-Type set to geran-ps.

If the ue-CapabilityRequest includes utra and if the UE supports UTRA, then the UE 102 may include the UE radio access capabilities for UTRA within a ue-CapabilityRAT-Container and with the rat-Type set to utra.

If the ue-CapabilityRequest includes cdma2000-1×RTT and if the UE 102 supports CDMA2000 1×RTT, then the UE 102 may include the UE radio access capabilities for CDMA2000 within a ue-CapabilityRAT-Container and with the rat-Type set to cdma2000-1×RTT.

The UE 102 may submit the UECapabilityInformation message to lower layers for transmission, upon which the procedure ends.

Message definitions are also described herein. The message UECapabilityInformation may be defined. The UECapabilityInformation message is used to transfer of UE radio access capabilities requested by the E-UTRAN. The signaling radio bearer may be SRB1, the RLC-SAP may be AM, the Logical channel may be Dedicated Control Channel (DCCH) and the direction may be UE to E-UTRAN. An example of a UECapabilityInformation message is provided in Listing-1.

Listing-1

-- ASN1START

| UECapabilityInformation ::= | | SEQUENCE { |
|---|---|---|
| rrc-TransactionIdentifier | | RRC-TransactionIdentifier, |
| criticalExtensions | | CHOICE { |
| | c1 | CHOICE{ |

| | |
|---|---|
| ueCapabilityInformation-r8 | UECapabilityInformation- |

r8-IEs,

| spare7 NULL, | |
|---|---|
| spare6 NULL, spare5 NULL, spare4 NULL, | |
| spare3 NULL, spare2 NULL, spare1 NULL | |
| }, | |
| criticalExtensionsFuture | SEQUENCE { } |

}
}
UECapabilityInformation-r8-IEs ::= SEQUENCE {

| | |
|---|---|
| ue-CapabilityRAT-ContainerList | UE-CapabilityRAT-ContainerList, |
| nonCriticalExtension | UECapabilityInformation-v8a0-IEs |

OPTIONAL
}
UECapabilityInformation-v8a0-IEs ::= SEQUENCE {

| | |
|---|---|
| lateNonCriticalExtension | OCTET STRING |

OPTIONAL,

| | |
|---|---|
| nonCriticalExtension | UECapabilityInformation-v1250-IEs |

OPTIONAL
}
UECapabilityInformation-v1250-IEs ::= SEQUENCE {

| | |
|---|---|
| ue-RadioPagingInfo-r12 | UE-RadioPagingInfo-r12 |

OPTIONAL,

| | |
|---|---|
| nonCriticalExtension | SEQUENCE { } |

OPTIONAL
}

| NR-UECapabilityInformation ::= | | SEQUENCE { |
|---|---|---|
| rrc-TransactionIdentifier | | RRC-TransactionIdentifier, |
| criticalExtensions | | CHOICE { |
| | c1 | CHOICE{ |

NR-ueCapabilityInformation-r14

UECapabilityInformation-r14-IEs,

| spare7 NULL, | |
|---|---|
| spare6 NULL, spare5 NULL, spare4 NULL, | |
| spare3 NULL, spare2 NULL, spare1 NULL | |
| }, | |
| criticalExtensionsFuture | SEQUENCE { } |

}
}
NR-UECapabilityInformation-v1400-IEs ::= SEQUENCE {

| | |
|---|---|
| NR-ue-RadioPagingInfo-r14 | NR-UE-RadioPagingInfo-r14 |

OPTIONAL,

| | |
|---|---|
| nonCriticalExtension | SEQUENCE { } |

OPTIONAL
}
-- ASN1STOP

In Listing-1, possible modifications to the UECapabilityInformation message are in bold. In the UECapabilityInformation message, the ue-RadioPagingInfo field contains UE capability information used for paging.

A UEInformationRequest message is also described. The UEInformationRequest is the command used by E-UTRAN to retrieve information from the UE. The Signaling radio bearer may be SRB1, the RLC-SAP may be AM, the logical channel may be DCCH, and the direction may be E-UTRAN to UE. An example of the UEInformationRequest message is provided in Listing-2.

Listing-2

-- ASN1START

| | |
|---|---|
| UEInformationRequest-r9 ::= | SEQUENCE { |

| rrc-TransactionIdentifier | | RRC-TransactionIdentifier, | |
|---|---|---|---|
| criticalExtensions | | CHOICE { | |
| | c1 | CHOICE { | |
| | ueInformationRequest-r9 | | UEInformationRequest-r9- |

IEs,

| spare3 NULL, spare2 NULL, spare1 NULL | |
|---|---|
| }, | |
| criticalExtensionsFuture | SEQUENCE { } |

}
}

| | |
|---|---|
| UEInformationRequest-r9-IEs ::= | SEQUENCE { |
| rach-ReportReq-r9 | BOOLEAN, |
| rlf-ReportReq-r9 | BOOLEAN, |
| nonCriticalExtension | UEInformationRequest-v930-IEs |

OPTIONAL
}
UEInformationRequest-v930-IEs ::= SEQUENCE {

| | |
|---|---|
| lateNonCriticalExtension | OCTET STRING |

OPTIONAL,

| | |
|---|---|
| nonCriticalExtension | UEInformationRequest-v1020-IEs |

OPTIONAL
}
UEInformationRequest-v1020-IEs ::= SEQUENCE {

| | |
|---|---|
| logMeasReportReq-r10 | ENUMERATED {true} |

OPTIONAL, -- Need ON

| | |
|---|---|
| nonCriticalExtension | UEInformationRequest-v1130-IEs |

OPTIONAL
}
UEInformationRequest-v1130-IEs ::= SEQUENCE {

| | |
|---|---|
| connEstFailReportReq-r11 | ENUMERATED {true} |

OPTIONAL, -- Need ON

| | |
|---|---|
| nonCriticalExtension | UEInformationRequest-v1250-IEs |

OPTIONAL
}
UEInformationRequest-v1250-IEs ::= SEQUENCE {

| | |
|---|---|
| mobilityHistoryReportReq-r12 | ENUMERATED {true} |

OPTIONAL, -- Need ON

| | |
|---|---|
| nonCriticalExtension | SEQUENCE { } |

OPTIONAL
}
//NR-Addition as a Delta to uTRAN
UEInformationRequest-v1400-IEs ::= SEQUENCE {

| | |
|---|---|
| UE-Based-mobilityReportReq-r14 | ENUMERATED {true} |

OPTIONAL, -- Need ON

| | |
|---|---|
| nonCriticalExtension | SEQUENCE { } |

OPTIONAL
}
//OR
//NR-Addition as part of new construct

| | |
|---|---|
| NR-UEInformationRequest-r14 ::= | SEQUENCE { |

| rrc-TransactionIdentifier | | RRC-TransactionIdentifier, |
|---|---|---|
| criticalExtensions | | CHOICE { |
| | c1 | CHOICE { |

| | |
|---|---|
| NR-ueInformationRequest-r14 | NR-UEInformationRequest- |

r9-IEs,

| spare3 NULL, spare2 NULL, spare1 NULL | |
|---|---|
| }, | |
| criticalExtensionsFuture | SEQUENCE { } |

}
}

| | |
|---|---|
| NR-UEInformationRequest-r14-IEs ::= | SEQUENCE { |

| | |
|---|---|
| rach-ReportReq-r14 | BOOLEAN, |
| UE-based-HO-Req-r14 | BOOLEAN, |
| rlf-ReportReq-r14 | BOOLEAN, |
| nonCriticalExtension | NR-UEInformationRequest-IEs |

OPTIONAL
}
-- ASN1STOP

In Listing-2, possible modifications to the UEInformationRequest message are in bold. In the UEInformationRequest message, the rach-ReportReq field is used to indicate whether the UE 102 shall report information about the random access procedure.

A UEInformationResponse message is also described. The UEInformationResponse message is used by the UE 102 to transfer the information requested by the E-UTRAN. The signaling radio bearer may be SRB1 or SRB2 (when logged measurement information is included); the RLC-SAP may be AM; the logical channel may be DCCH; and the direction may be UE to E-UTRAN. An example of the UEInformationResponse message is provided in Listing-3.

In Listing-3, possible modifications to the UEInformationResponse message are in bold. In the UEInformationResponse message, absoluteTimeStamp indicates the absolute time when the logged measurement configuration logging is provided, as indicated by E-UTRAN within absoluteTimeInfo.

The field bler indicates the measured BLER value. The coding of BLER value may be defined in TS 36.133.

The field blocksReceived may indicate the total number of MCH blocks, which were received by the UE 102 and used for the corresponding BLER calculation, within the measurement period as defined in TS 36.133.

Regarding the field carrierFreq, in the case that the UE 102 includes carrierFreq-v9e0 and/or carrierFreq-v1090, the UE 102 shall set the corresponding entry of carrierFreq-r9 and/or carrierFreq-r10 respectively to maxEARFCN. For E-UTRA and UTRA frequencies, the UE 102 sets the ARFCN according to the band used when obtaining the concerned measurement results.

The field connectionFailureType is used to indicate whether the connection failure is due to radio link failure or handoff failure.

The field contentionDetected is used to indicate that contention was detected for at least one of the transmitted preambles.

The field c-RNTI indicates the C-RNTI used in the PCell upon detecting radio link failure or the C-RNTI used in the source PCell upon handoff failure.

The field dataBLER-MCH-ResultList includes a BLER result per MCH on subframes using dataMCS, with the applicable MCH(s) listed in the same order as in pmch-InfoList within MBSFNAreaConfiguration.

The field drb-EstablishedWithQCI-1 is used to indicate the radio link failure occurred while a bearer with QoS Class Identifier (QCI) value equal to 1 was configured.

The field failedCellId is used to indicate the cell in which connection establishment failed.

The field failedPCellId is used to indicate the PCell in which RLF is detected or the target PCell of the failed handoff. The UE 102 sets the EARFCN according to the band used for transmission/reception when the failure occurred.

The field inDeviceCoexDetected indicates that measurement logging is suspended due to IDC problem detection.

The field maxTxPowerReached is used to indicate whether or not the maximum power level was used for the last transmitted preamble.

The field inch-Index indicates the MCH by referring to the entry as listed in pmch-InfoList within MBSFNAreaConfiguration.

The field measResultFailedCell refers to the last measurement results taken in the cell, where connection establishment failure happened.

The field measResultLastServCell refers to the last measurement results taken in the PCell, where radio link failure or handoff failure happened.

For the field measResultListEUTRA, if measResultListEUTRA-v9e0, measResultListEUTRA-v1090 or measResultListEUTRA-v1130 is included, the UE 102 shall include the same number of entries, and listed in the same order, as in measResultListEUTRA-r9, measResultListEUTRA-r10 and/or measResultListEUTRA-r11 respectively.

For the field measResultListEUTRA-v1250, if included in RLF-Report-r9 the UE 102 shall include the same number of entries, and listed in the same order, as in measResultListEUTRA-r9. If included in LogMeasInfo-r10 the UE 102 shall include the same number of entries, and listed in the same order, as in measResultListEUTRA-r10. If included in ConnEstFailReport-r11 the UE 102 shall include the same number of entries, and listed in the same order, as in measResultListEUTRA-r11.

The field mobilityHistoryReport is used to indicate the time of stay in 16 most recently visited E-UTRA cells or of stay out of E-UTRA.

The field numberOfPreamblesSent is used to indicate the number of RACH preambles that were transmitted. This corresponds to parameter PREAMBLE_TRANSMISSION_COUNTER in TS 36.321.

The field previousPCellId is used to indicate the source PCell of the last handoff (source PCell when the last RRC-Connection-Reconfiguration message including mobilityControlInfowas received).

The field previousUTRA-CellId is used to indicate the source UTRA cell of the last successful handoff to E-UTRAN, when RLF occurred at the target PCell. The UE 102 sets the ARFCN according to the band used for transmission/reception on the concerned cell.

The field reestablishmentCellId is used to indicate the cell in which the re-establishment attempt was made after connection failure.

The field relativeTimeStamp indicates the time of logging measurement results, measured relative to the absoluteTimeStamp. The value may be in seconds.

The field rlf-Cause is used to indicate the cause of the last radio link failure that was detected. In case of handoff failure information reporting (i.e., the connectionFailureType is set to ‘hof’), the UE 102 is allowed to set this field to any value.

The field selectedUTRA-CellId is used to indicate the UTRA cell that the UE 102 selects after RLF is detected, while T311 is running. The UE 102 sets the ARFCN according to the band selected for transmission/reception on the concerned cell.

The field signallingBLER-Result includes a BLER result of MBSFN subframes using signallingMCS.

The field tac-FailedPCell is used to indicate the Tracking Area Code of the PCell in which RLF is detected.

The field tce-Id is a parameter Trace Collection Entity Id.

The field timeConnFailure is used to indicate the time elapsed since the last HO initialization until connection failure. The actual value=field value*100 ms. The maximum value 1023 means 102.3 s or longer.

The field timeSinceFailure is used to indicate the time that elapsed since the connection (establishment) failure. The value may be in seconds. The maximum value 172800 means 172800 s or longer.

The field traceRecordingSessionRef is a parameter trace recording session reference.

A UE-EUTRA-Capability information element is also described. The UE-EUTRA-Capability information The is used to convey the EUTRA UE Radio Access Capability Parameters, and the Feature Group Indicators for mandatory features to the network. The IE UE-EUTRA-Capability is transferred in E-UTRA or in another RAT. An example of the UE-EUTRA-Capability information element is provided in Listing-4.

Listing-4

| | |
|---|---|
| -- ASN1START | |
| UE-EUTRA-Capability ::= | SEQUENCE { |

| | |
|---|---|
| accessStratumRelease | AccessStratumRelease, |
| ue-Category | INTEGER (1..5), |
| pdcp-Parameters | PDCP-Parameters, |
| phyLayerParameters | PhyLayerParameters, |
| rf-Parameters | RF-Parameters, |
| measParameters | MeasParameters, |
| featureGroupIndicators | BIT STRING (SIZE (32)) |
| OPTIONAL, | |

| | |
|---|---|
| interRAT-Parameters | SEQUENCE { |

| | |
|---|---|
| nr-utraFDD | IRAT-ParametersNR-UTRA-FDD |
| OPTIONAL, | |
| nr-utraTDDxxx | IRAT-ParametersNR-UTRA-TDDxxx |
| OPTIONAL, | |
| utraFDD | IRAT-ParametersUTRA-FDD |
| OPTIONAL, | |
| utraTDD128 | IRAT-ParametersUTRA-TDD128 |
| OPTIONAL, | |
| utraTDD384 | IRAT-ParametersUTRA-TDD384 |
| OPTIONAL, | |
| utraTDD768 | IRAT-ParametersUTRA-TDD768 |
| OPTIONAL, | |
| geran | IRAT-ParametersGERAN |
| OPTIONAL, | |
| cdma2000-HRPD | IRAT-ParametersCDMA2000-HRPD |
| OPTIONAL, | |
| cdma2000-1xRTT | IRAT-ParametersCDMA2000-1XRTT |
| OPTIONAL | |
| }, | |
| nonCriticalExtension | UE-EUTRA-Capability-v920-IEs |
| OPTIONAL | |
| } | |
| -- Late non critical extensions | |
| UE-EUTRA-Capability-v9a0-IEs ::= | SEQUENCE { |
| featureGroupIndRel9Add-r9 | BIT STRING (SIZE (32)) |
| OPTIONAL, | |
| fdd-Add-UE-EUTRA-Capabilities-r9 | UE-EUTRA-CapabilityAddXDD-Mode- |
| r9 OPTIONAL, | |
| tdd-Add-UE-EUTRA-Capabilities-r9 | UE-EUTRA-CapabilityAddXDD-Mode- |
| r9 OPTIONAL, | |
| nonCriticalExtension | UE-EUTRA-Capability-v9c0-IEs |
| OPTIONAL | |
| } | |
| ... . . | |
| FreqBandIndicatorListEUTRA-r12 ::= | SEQUENCE (SIZE (1..maxBands)) |
| OF FreqBandIndicator-r11 | |
| //NR-Addition as a Delta to uTRAN | |

```
UE-Based-mobility-support-r14 ENUMERATED {true} OPTIONAL,
//OR
//NR-Addition as part of new construct
NR-UE-Based-mobility-support-r14 ::= SEQUENCE {
            UE-Based-mobilityReportResponse-r14 ENUMERATED {true}
    OPTIONAL,
                spare3 NULL, spare2 NULL, spare1 NULL
}
-- ASN1STOP
```

In Listing-4, possible modifications to the UE-EUTRA-Capability information element are in bold. The nr-utraFDD field indicates whether the UE 102 supports 5G NR FDD. The nr-utraTDDxxx field indicates whether the UE supports 5G NR TDD (xxx: 128,384, . . . ). The NR-UE-Based-mobility-support-r14 indicates whether the UE 102 supports UE-based handoff Feature in 5G NR.

A UE-NRUTRA-Capability information element is also described. The IE UE-NRUTRA-Capability is used to convey the NR-UTRA UE radio access capability parameters, and the feature group indicators for mandatory features to the network. The IE UE-NRUTRA-Capability is transferred in NR-UTRA or in another RAT. An example of the UE-NRUTRA-Capability information element is provided in Listing-5.

Listing-5

| | |
|---|---|
| -- ASN1START | |
| UE-NRUTRA-Capability ::= | SEQUENCE { |

| | |
|---|---|
| accessStratumRelease | AccessStratumRelease, |
| ue-Category | INTEGER (1..5), |
| pdcp-Parameters | PDCP-Parameters, |
| phyLayerParameters | PhyLayerParameters, |
| rf-Parameters | RF-Parameters, |
| measParameters | MeasParameters, |
| featureGroupIndicators | BIT STRING (SIZE (32)) |
| OPTIONAL, | |

| | |
|---|---|
| interRAT-Parameters | SEQUENCE { |

| | |
|---|---|
| nr-utraFDD | IRAT-ParametersNR-UTRA-FDD |
| OPTIONAL, | |
| nr-utraTDDxxx | IRAT-ParametersNR-UTRA-TDDxxx |
| OPTIONAL, | |
| eutraFDD | IRAT-ParametersEUTRA-FDD |
| OPTIONAL, | |
| eutraTDDxyz | IRAT-ParametersEUTRA-TDDxyz |
| OPTIONAL, | |
| utraFDD | IRAT-ParametersUTRA-FDD |
| OPTIONAL, | |
| utraTDD128 | IRAT-ParametersUTRA-TDD128 |
| OPTIONAL, | |
| utraTDD384 | IRAT-ParametersUTRA-TDD384 |
| OPTIONAL, | |
| utraTDD768 | IRAT-ParametersUTRA-TDD768 |
| OPTIONAL, | |
| geran | IRAT-ParametersGERAN |
| OPTIONAL, | |
| cdma2000-HRPD | IRAT-ParametersCDMA2000-HRPD |
| OPTIONAL, | |
| cdma2000-1xRTT | IRAT-ParametersCDMA2000-1XRTT |
| OPTIONAL | |
| }, | |

| | |
|---|---|
| nonCriticalExtension | UE-EUTRA-Capability-v920-IEs |
| OPTIONAL | |
| } | |
| -- Late non critical extensions | |
| UE-EUTRA-Capability-v9a0-IEs ::= | SEQUENCE { |
| featureGroupIndRel9Add-r9 | BIT STRING (SIZE (32)) |
| OPTIONAL, | |
| fdd-Add-UE-EUTRA-Capabilities-r9 | UE-EUTRA-CapabilityAddXDD-Mode- |
| r9 OPTIONAL, | |
| tdd-Add-UE-EUTRA-Capabilities-r9 | UE-EUTRA-CapabilityAddXDD-Mode- |
| r9 OPTIONAL, | |

| | |
|---|---|
| nonCriticalExtension | UE-EUTRA-Capability-v9c0-IEs |
| OPTIONAL | |
| } | |
| ... . . | |

| | |
|---|---|
| FreqBandIndicatorListEUTRA-r12 ::= | SEQUENCE (SIZE (1..maxBands)) |
| OF FreqBandIndicator-r11 | |
| NR-Addition as a Delta to uTRAN | |

| UE-Based-mobility-support-r14 | ENUMERATED {true} | |
|---|---|---|
| OPTIONAL, | | |
| OR | | |
| NR-Addition as part of new construct | | |
| NR-UE-Based-mobility-support-r14 | ::= | SEQUENCE { |

| | |
|---|---|
| UE-Based-mobilityReportResponse-r14 | ENUMERATED {true} |

spare3 NULL, spare2 NULL, spare1 NULL
}
-- ASN1STOP

In Listing-5, possible modifications to the UE-NRUTRA-Capability information element are in bold. The nr-utraFDD field indicates whether the UE 102 supports 5G NR FDD. The nr-utraTDDxxx field indicates whether the UE 102 supports 5G NR TDD (xxx: 128,384, . . . ). The eutraFDD field indicates whether the UE 102 supports EUTRA FDD. The eutraTDDxxx field indicates whether the UE 102 supports EUTRA TDD. The NR-UE-Based-mobility-support-r14 field indicates whether the UE 102 supports UE-based handoff Feature.

Radio information related interactions between network nodes are also described. RRC messages may be transferred between network nodes. These RRC messages may be transferred to or from the UE via another Radio Access Technology. Consequently, these messages have similar characteristics as the RRC messages that are transferred across the E-UTRA radio interface. In other words, the same transfer syntax and protocol extension mechanisms apply.

An RRCConnectionUeBasedHo message may be used to command the enablement of a UE-Based handoff feature connection. The signaling radio bearer may be SRB1, the RLC-SAP may be AM, the logical channel may be DCCH and the direction may be E-UTRAN to UE. An example of the RRCConnectionUeBasedHo message is provided in Listing-6.

Listing-6

| | |
|---|---|
| -- ASN1START | |
| RRCConnectionUeBasedHo ::= | SEQUENCE { |
| rrc-TransactionIdentifier | RRC-TransactionIdentifier, |
| criticalExtensions | CHOICE { |
| c1 | CHOICE { |

```
          RRCConnectionUeBasedHo-r14
    RRCConnectionUeBasedHo-r14-IEs,
          spare3 NULL, spare2 NULL, spare1 NULL
      },
```

| | |
|---|---|
| criticalExtensionsFuture | SEQUENCE { } |
| } | |
| } | |
| RRCConnectionUeBasedHo-r14-IEs::= | SEQUENCE { |

| | |
|---|---|
| redirectedCarrierInfo | RedirectedCarrierInfo |
| OPTIONAL, -- Need ON | |
| connectedModeMobilityControlInfo | |

| | |
|---|---|
| ConnectedModeMobilityControlInfo | OPTIONAL, -- Need OP |
| idleModeMobilityControlInfo | IdleModeMobilityControlInfo |
| OPTIONAL, -- Need OP | |

| | |
|---|---|
| nonCriticalExtension | RRCConnectionUeBasedHo-v1400-IEs |
| OPTIONAL | |
| } | |

-- Late non critical extensions

| | |
|---|---|
| RRCConnectionUeBasedHo-v1400-IEs | ::= SEQUENCE { |

| | |
|---|---|
| redirectedCarrierInfo | RedirectedCarrierInfo |
| OPTIONAL-- Cond NoRedirect | |
| connectedModeMobilityControlInfo | |

| | |
|---|---|
| ConnectedModeMobilityControlInfo | OPTIONAL, -- Need OP |

| | |
|---|---|
| idleModeMobilityControlInfo | IdleModeMobilityControlInfo |
| OPTIONAL, -- Cond | |
| IdleInfoNRUTRA | |

| | |
|---|---|
| nonCriticalExtension | SEQUENCE { } |
| OPTIONAL | |
| } | |
| -- Regular non critical extensions | |

| | |
|---|---|
| RRCConnectionUeBasedHo-v1400-IEs | ::= SEQUENCE { |

| | |
|---|---|
| cellInfoList-rx | CHOICE { |
| nrutra-FDD-rx | CellInfoListNRUTRA-FDD-rx, |
| nrutra-TDD-rx | CellInfoListNRUTRA-TDD-rx, |
| eutra-FDD-rx | CellInfoListEUTRA-FDD-rx, |
| eutra-TDD-rx | CellInfoListEUTRA-TDD-rx, |
| geran-rx | CellInfoListGERAN-rx, |
| utra-FDD-rx | CellInfoListUTRA-FDD-rx, |
| utra-TDD-rx | CellInfoListUTRA-TDD-rx, |
| ..., | |

| | |
|---|---|
| utra-TDD-ry | CellInfoListUTRA-TDD-ry |

| | |
|---|---|
| } | OPTIONAL, -- Cond |
| Redirection | |

| | |
|---|---|
| nonCriticalExtension | RRCConnectionUeBasedHo-v1400-IEs |
| OPTIONAL | |
| } | |
| RedirectedCarrierInfo ::= | CHOICE { |
| NR-utra | ARFCN-ValueNR-UTRA, |
| eutra | ARFCN-ValueEUTRA, |
| geran | CarrierFreqsGERAN, |
| utra-FDD | ARFCN-ValueUTRA, |
| utra-TDD | ARFCN-ValueUTRA, |
| cdma2000-HRPD | CarrierFreqCDMA2000, |
| cdma2000-1xRTT | CarrierFreqCDMA2000, |
| ..., | |
| utra-TDD-rxy | CarrierFreqListUTRA-TDD-rxy |
| } | |

| | |
|---|---|
| RedirectedCarrierInfo-vxey ::= | SEQUENCE { |
| eutra-vxey | ARFCN-ValueEUTRA-vxey |
| } | |
| CarrierFreqListUTRA-TDD-rxy ::= | SEQUENCE (SIZE (1..maxFreqUTRA- |
| TDD-rxy)) OF ARFCN-ValueUTRA | |

| | |
|---|---|
| ConnectedModeMobilityControlInfo ::= | SEQUENCE { |

| | |
|---|---|
| freqPriorityListNRUTRA | FreqPriorityListNRUTRA |
| OPTIONAL, -- Need ON | |
| freqPriorityListEUTRA | FreqPriorityListEUTRA |
| OPTIONAL, -- Need ON | |
| freqPriorityListGERAN | FreqsPriorityListGERAN |
| OPTIONAL, -- Need ON | |
| freqPriorityListUTRA-FDD | FreqPriorityListUTRA-FDD |
| OPTIONAL, -- Need ON | |
| freqPriorityListUTRA-TDD | FreqPriorityListUTRA-TDD |
| OPTIONAL, -- Need ON | |
| bandClassPriorityListHRPD | BandClassPriorityListHRPD |
| OPTIONAL, -- Need ON | |
| bandClassPriorityList1XRTT | BandClassPriorityList1XRTT |
| OPTIONAL, -- Need ON | |
| t320 | ENUMERATED { |
| | min5, min10, min20, min30, min60, |
| | min120, min180, |
| | spare1} OPTIONAL, -- Need OR |
| ..., | |
| [[ freqPriorityListExtEUTRA-r12 | FreqPriorityListExtEUTRA-r12 |
| OPTIONAL-- Need ON | |
| ]], | |

| | |
|---|---|
| [[ freqPriorityListEUTRA-v1310 | FreqPriorityListEUTRA-v1310 |
| OPTIONAL-- Need ON | |
| freqPriorityListExtEUTRA-v1310 | FreqPriorityListExtEUTRA- |
| v1310 OPTIONAL-- Need ON | |
| ]] | |
| } | |

ConnectedModeMobilityControlInfo-v ::=SEQUENCE {

| | |
|---|---|
| freqPriorityListEUTRA-v9e0 | SEQUENCE (SIZE (1..maxFreq)) OF |
| FreqPriorityEUTRA-v9e0 | |
| } | |
| FreqPriorityListEUTRA ::= | SEQUENCE (SIZE (1..maxFreq)) OF |
| FreqPriorityEUTRA | |
| FreqPriorityListExtEUTRA-r12 ::= | SEQUENCE (SIZE (1..maxFreq)) OF |
| FreqPriorityEUTRA-r12 | |
| FreqPriorityListEUTRA-v1310 ::= | SEQUENCE (SIZE (1..maxFreq)) OF |
| FreqPriorityEUTRA-v1310 | |
| FreqPriorityListExtEUTRA-v1310 ::= | SEQUENCE (SIZE (1..maxFreq)) OF |
| FreqPriorityEUTRA-v1310 | |

| | |
|---|---|
| FreqPriorityNRUTRA ::= | SEQUENCE { |
| carrierFreq | ARFCN-ValueNRUTRA, |
| cellHoPriority | CellHoPriority |

| | |
|---|---|
| NR-rrcConnectionReconfiguration-rxy | NR- |

RRCConnectionReconfiguration-rxy-IEs
RRCConnectionReconfiguration-rxy-IEs ::= SEQUENCE {

| | |
|---|---|
| NR-measConfig | NR-MeasConfig |
| OPTIONAL, -- Need ON | |
| NR-mobilityControlInfo | NR-MobilityControlInfo |
| OPTIONAL, -- Cond HO | |

| | |
|---|---|
| NR-dedicatedInfoNASList | SEQUENCE (SIZE(1..maxDRB)) OF |

| | |
|---|---|
| NR-DedicatedInfoNAS | OPTIONAL, -- Cond nonHO |

| | |
|---|---|
| NR-radioResourceConfigDedicated | NR-RadioResourceConfigDedicated |
| OPTIONAL, -- Cond HO-toNR-UTRA | |

| | |
|---|---|
| NR-securityConfigHO | NR-SecurityConfigHO |
| OPTIONAL, -- Cond HO | |
| nonCriticalExtension | NR-RRCConnectionReconfiguration- |
| v890-IEs OPTIONAL | |
| } | |

NR-systemInformationBlockType(1-8)Dedicated-rxy OCTET STRING
(CONTAINING SystemInformationBlockType(1-8))

| | |
|---|---|
| FreqPriorityEUTRA ::= | SEQUENCE { |
| carrierFreq | ARFCN-ValueEUTRA, |

| | |
|---|---|
| cellHoPriority | CellHoPriority |

| | |
|---|---|
| rrcConnectionReconfiguration-rxy | RRCConnectionReconfiguration- |
| rxy-IEs | |
| } | |

| | |
|---|---|
| FreqPriorityEUTRA-v9e0 ::= | SEQUENCE { |
| carrierFreq-v9e0 | ARFCN-ValueEUTRA-v9e0 OPTIONAL - |
| } | |
| FreqPriorityEUTRA-r12 ::= | SEQUENCE { |

| | |
|---|---|
| carrierFreq-r12 | ARFCN-ValueEUTRA-r9, |

| | |
|---|---|
| cellHoPriority | CellHoPriority |

| | |
|---|---|
| rrcConnectionReconfiguration-rxy | RRCConnectionReconfiguration- |
| rxy-IEs | |
| } | |
| FreqPriorityEUTRA-v1310 ::= | SEQUENCE { |

| | |
|---|---|
| cellHoPriority | CellHoPriority OPTIONAL -- Need |
| ON | |

| | |
|---|---|
| rrcConnectionReconfiguration-rxy | RRCConnectionReconfiguration- |
| rxy-IEs | |
| } | |

| | |
|---|---|
| FreqsPriorityListGERAN ::= | SEQUENCE (SIZE (1..maxGNFG)) OF |
| FreqsPriorityGERAN | |

| | |
|---|---|
| FreqsPriorityGERAN ::= | SEQUENCE { |
| carrierFreqs | CarrierFreqsGERAN, |

| | |
|---|---|
| cellHoPriority | CellHoPriority } |

| | |
|---|---|
| FreqPriorityListUTRA-FDD ::= | SEQUENCE (SIZE (1..maxUTRA-FDD- |

Carrier)) OF FreqPriorityUTRA-FDD

| | |
|---|---|
| FreqPriorityUTRA-FDD ::= | SEQUENCE { |
| carrierFreq | ARFCN-ValueUTRA, |

| | |
|---|---|
| cellHoPriority | CellHoPriority |
| } | |

| | |
|---|---|
| FreqPriorityListUTRA-TDD ::= | SEQUENCE (SIZE (1..maxUTRA-TDD- |

Carrier)) OF FreqPriorityUTRA-TDD

| | |
|---|---|
| FreqPriorityUTRA-TDD ::= | SEQUENCE { |
| carrierFreq | ARFCN-ValueUTRA, |

| | |
|---|---|
| cellHoPriority | CellHoPriority |

| | |
|---|---|
| rrcConnectionReconfiguration-rxy | RRCConnectionReconfiguration- |
| rxy-IEs | |
| } | |

| | |
|---|---|
| BandClassPriorityListHRPD ::= | SEQUENCE (SIZE (1..maxCDMA- |

BandClass)) OF BandClassPriorityHRPD

| | |
|---|---|
| BandClassPriorityHRPD ::= | SEQUENCE { |
| bandClass | BandclassCDMA2000, |

| | |
|---|---|
| cellHoPriority | CellHoPriority |
| } | |

| | |
|---|---|
| BandClassPriorityList1XRTT ::= | SEQUENCE (SIZE (1..maxCDMA-BandClass)) |
| OF BandClassPriority1XRTT | |
| BandClassPriority1XRTT ::= | SEQUENCE { |
| bandClass | BandclassCDMA2000, |

| | |
|---|---|
| cellHoPriority | CellHoPriority |
| } | |
| CellInfoListGERAN-r9 ::= | SEQUENCE (SIZE (1..maxCellInfoGERAN-r9)) |
| OF CellInfoGERAN-r9 | |

| | |
|---|---|
| CellInfoGERAN-r9 ::= | SEQUENCE { |

| | |
|---|---|
| physCellId-r9 | PhysCellIdGERAN, |
| carrierFreq-r9 | CarrierFreqGERAN, |
| systemInformation-r9 | SystemInfoListGERAN |
| } | |
| CellInfoListUTRA-FDD-r9 ::= | SEQUENCE (SIZE (1..maxCellInfoUTRA- |
| r9)) OF CellInfoUTRA-FDD-r9 | |
| CellInfoUTRA-FDD-r9 ::= | SEQUENCE { |
| physCellId-r9 | PhysCellIdUTRA-FDD, |
| utra-BCCH-Container-r9 | OCTET STRING |
| } | |
| CellInfoListUTRA-TDD-r9 ::= | SEQUENCE (SIZE (1..maxCellInfoUTRA- |
| r9)) OF CellInfoUTRA-TDD-r9 | |
| CellInfoUTRA-TDD-r9 ::= | SEQUENCE { |
| physCellId-r9 | PhysCellIdUTRA-TDD, |
| utra-BCCH-Container-r9 | OCTET STRING |
| } | |

| | |
|---|---|
| CellInfoListUTRA-TDD-r10 ::= | SEQUENCE (SIZE (1..maxCellInfoUTRA- |
| r9)) OF CellInfoUTRA-TDD-r10 | |
| CellInfoUTRA-TDD-r10 ::= | SEQUENCE { |

| | |
|---|---|
| physCellId-r10 | PhysCellIdUTRA-TDD, |
| carrierFreq-r10 | ARFCN-ValueUTRA, |
| utra-BCCH-Container-r10 | OCTET STRING |
| } | |
| IdleModeMobilityControlInfo ::= | SEQUENCE { |
| freqPriorityListNRUTRA | FreqPriorityListNRUTRA |
| OPTIONAL, -- Need ON | |
| freqPriorityListEUTRA | FreqPriorityListEUTRA |
| OPTIONAL, -- Need ON | |
| freqPriorityListGERAN | FreqsPriorityListGERAN |
| OPTIONAL, -- Need ON | |
| freqPriorityListUTRA-FDD | FreqPriorityListUTRA-FDD |
| OPTIONAL, -- Need ON | |
| freqPriorityListUTRA-TDD | FreqPriorityListUTRA-TDD |
| OPTIONAL, -- Need ON | |
| bandClassPriorityListHRPD | BandClassPriorityListHRPD |
| OPTIONAL, -- Need ON | |
| bandClassPriorityList1XRTT | BandClassPriorityList1XRTT |
| OPTIONAL, -- Need ON | |
| t320 | ENUMERATED { |
| | min5, min10, min20, min30, min60, |
| | min120, min180, |
| | spare1} OPTIONAL, -- Need OR |
| ..., | |

| | |
|---|---|
| [[ freqPriorityListExtEUTRA-r12 | FreqPriorityListExtEUTRA-r12 |
| OPTIONAL -- Need ON | |
| ]], | |
| [[ freqPriorityListEUTRA-v1310 | FreqPriorityListEUTRA-v1310 |
| OPTIONAL, -- Need ON | |
| freqPriorityListExtEUTRA-v1310 | FreqPriorityListExtEUTRA-v1310 |
| OPTIONAL -- Need ON | |
| ]] | |
| } | |
| IdleModeMobilityControlInfo-v9e0 ::= | SEQUENCE { |
| freqPriorityListEUTRA-v9e0 | SEQUENCE (SIZE (1..maxFreq)) OF |
| FreqPriorityEUTRA-v9e0 | |
| } | |

| | |
|---|---|
| FreqPriorityListEUTRA ::= | SEQUENCE (SIZE (1..maxFreq)) OF |
| FreqPriorityEUTRA | |

| | |
|---|---|
| FreqPriorityListExtEUTRA-r12 ::= | SEQUENCE (SIZE (1..maxFreq)) OF |
| FreqPriorityEUTRA-r12 | |
| FreqPriorityListEUTRA-v1310 ::= | SEQUENCE (SIZE (1..maxFreq)) OF |
| FreqPriorityEUTRA-v1310 | |
| FreqPriorityListExtEUTRA-v1310 ::= | SEQUENCE (SIZE (1..maxFreq)) OF |
| FreqPriorityEUTRA-v1310 | |

| | |
|---|---|
| FreqPriorityEUTRA ::= | SEQUENCE { |

| | |
|---|---|
| carrierFreq | ARFCN-ValueEUTRA, |

| | |
|---|---|
| cellReselectionPriority | CellReselectionPriority |
| } | |

| | |
|---|---|
| FreqPriorityEUTRA-v9e0 ::= | SEQUENCE { |
| carrierFreq-v9e0 | ARFCN-ValueEUTRA-v9e0 |

OPTIONAL -- Cond EARFCN-max
}

| | |
|---|---|
| FreqPriorityEUTRA-r12 ::= | SEQUENCE { |

| | |
|---|---|
| carrierFreq-r12 | ARFCN-ValueEUTRA-r9, |

| | |
|---|---|
| cellReselectionPriority-r12 | CellReselectionPriority |
| } | |

| | |
|---|---|
| FreqPriorityEUTRA-v1310 ::= | SEQUENCE { |
| cellReselectionSubPriority-r13 | |
| CellReselectionSubPriority-r13 | OPTIONAL -- Need ON |
| } | |

| | |
|---|---|
| FreqsPriorityListGERAN ::= | SEQUENCE (SIZE (1..maxGNFG)) OF |
| FreqsPriorityGERAN | |

| | |
|---|---|
| FreqsPriorityGERAN ::= | SEQUENCE { |
| carrierFreqs | CarrierFreqsGERAN, |

| | |
|---|---|
| cellReselectionPriority | CellReselectionPriority |
| } | |

| | |
|---|---|
| FreqPriorityListUTRA-FDD ::= | SEQUENCE (SIZE (1..maxUTRA-FDD- |
| Carrier)) OF FreqPriorityUTRA-FDD | |
| FreqPriorityUTRA-FDD ::= | SEQUENCE { |

| | |
|---|---|
| carrierFreq | ARFCN-ValueUTRA, |

| | |
|---|---|
| cellReselectionPriority | CellReselectionPriority |
| } | |

| | |
|---|---|
| FreqPriorityListUTRA-TDD ::= | SEQUENCE (SIZE (1..maxUTRA-TDD- |

Carrier)) OF FreqPriorityUTRA-TDD

| | |
|---|---|
| FreqPriorityUTRA-TDD ::= | SEQUENCE { |

| | |
|---|---|
| carrierFreq | ARFCN-ValueUTRA, |

| | |
|---|---|
| cellReselectionPriority | CellReselectionPriority |
| } | |

| | |
|---|---|
| BandClassPriorityListHRPD ::= | SEQUENCE (SIZE (1..maxCDMA- |
| BandClass)) OF BandClassPriorityHRPD | |

| | |
|---|---|
| BandClassPriorityHRPD ::= | SEQUENCE { |
| bandClass | BandclassCDMA2000, |

| | |
|---|---|
| cellReselectionPriority | CellReselectionPriority |
| } | |

| | |
|---|---|
| BandClassPriorityList1XRTT ::= | SEQUENCE (SIZE (1..maxCDMA-BandClass)) |
| OF BandClassPriority1XRTT | |

| | |
|---|---|
| BandClassPriority1XRTT ::= | SEQUENCE { |

| | |
|---|---|
| bandClass | BandclassCDMA2000, |

| | |
|---|---|
| cellReselectionPriority | CellReselectionPriority |
| } | |

| | |
|---|---|
| CellInfoListGERAN-r9 ::= | SEQUENCE (SIZE (1..maxCellInfoGERAN-r9)) |
| OF CellInfoGERAN-r9 | |

| | |
|---|---|
| CellInfoGERAN-r9 ::= | SEQUENCE { |

| | |
|---|---|
| physCellId-r9 | PhysCellIdGERAN, |
| carrierFreq-r9 | CarrierFreqGERAN, |
| systemInformation-r9 | SystemInfoListGERAN |
| } | |
| CellInfoListUTRA-FDD-r9 ::= | SEQUENCE (SIZE (1..maxCellInfoUTRA- |
| r9)) OF CellInfoUTRA-FDD-r9 | |
| CellInfoUTRA-FDD-r9 ::= | SEQUENCE { |
| physCellId-r9 | PhysCellIdUTRA-FDD, |
| utra-BCCH-Container-r9 | OCTET STRING |
| } | |
| CellInfoListUTRA-TDD-r9 ::= | SEQUENCE (SIZE (1..maxCellInfoUTRA- |
| r9)) OF CellInfoUTRA-TDD-r9 | |
| CellInfoUTRA-TDD-r9 ::= | SEQUENCE { |
| physCellId-r9 | PhysCellIdUTRA-TDD, |
| utra-BCCH-Container-r9 | OCTET STRING |
| } | |

| | |
|---|---|
| CellInfoListUTRA-TDD-r10 ::= | SEQUENCE (SIZE (1..maxCellInfoUTRA- |

r9)) OF CellInfoUTRA-TDD-r10

| | |
|---|---|
| CellInfoUTRA-TDD-r10 ::= | SEQUENCE { |

| | |
|---|---|
| physCellId-r10 | PhysCellIdUTRA-TDD, |
| carrierFreq-r10 | ARFCN-ValueUTRA, |
| utra-BCCH-Container-r10 | OCTET STRING |
| } | |
| -- ASN1STOP | |

In Listing-6, possible modifications to the RRCConnectionUeBasedHo message are in bold. The fields carrierFreq or bandClass indicate the carrier frequency (UTRA and E-UTRA) and band class (HRPD and 1×RTT) for which the associated cellHoPriority is applied.

The field NR-systemInformationBlockType(1-8) may be a dedicated-rxy with essential information used to convey one or more System Information Blocks (1-8) for each cell associated with this particular cell. For example, the IE SystemInformationBlockType3 contains cell re-selection/UE-based HO information common for intra-frequency, inter-frequency and/or inter-RAT cell re-selection/UE-HO as well as intra-frequency cell re-selection/UE-HO information other than neighboring cell related. Other definitions are listed in TS 36.331. These information facilitate access to the target cell.

The field carrierFreqs is the list of GERAN carrier frequencies organized into one group of GERAN carrier frequencies.

The field cellInfoList is used to provide system information of one or more cells on the redirected/handoff inter-RAT carrier frequency. The system information can be used if, upon redirection/HO, the UE handoff to an inter-RAT cell indicated by the physCellId and carrierFreq (GERAN and UTRA TDD) or by the physCellId (other RATs). The choice shall match the redirectedCarrierInfo. In particular, E-UTRAN only applies value utra-TDD-r10 in case redirectedCarrierInfo is set to utra-TDD-r10. The cellInfoList may include different RAT targets (e.g., NR-UTRA FDD and TDD, E-UTRA, . . . ).

The field extendedWaitTime is the value in seconds for the wait time for Delay Tolerant access requests.

The field freqPriorityListX provides a cell reselection priority for each frequency, by means of separate lists for each RAT (including E-UTRA). The UE 102 shall be able to store at least 3 occurrences of FreqsPriorityGERAN. If E-UTRAN includes freqPriorityListEUTRA-v9e0 and/or freqPriorityListEUTRA-v1310 it includes the same number of entries, and listed in the same order, as in freqPriorityListEUTRA (i.e. without suffix). Field freqPriorityListExt includes additional neighboring inter-frequencies (i.e., extending the size of the inter-frequency carrier list using the general principles specified in 5.1.2). E-UTRAN only includes freqPriorityListExtEUTRA if freqPriorityListEUTRA (i.e., without suffix) includes maxFreq entries. If E-UTRAN includes freqPriorityListExtEUTRA-v1310 it includes the same number of entries, and listed in the same order, as in freqPriorityListExtEUTRA-r12.

The field ConnectedModeMobilityControlInfo provides dedicated cell reselection priorities. This field is used for cell reselection as specified in TS 36.304. For E-UTRA and UTRA frequencies, an UE 102 that supports multi-band cells for the concerned RAT considers the dedicated priorities to be common for all overlapping bands (i.e., regardless of the ARFCN that is used). The ConnectedModeMobilityControlInfo IE may control HO target cell selection operation while the UE 102 is in Connected Mode.

The field idleModeMobilityControlInfo provides dedicated cell reselection priorities. This field is used for cell reselection as specified in TS 36.304. For E-UTRA and UTRA frequencies, a UE 102 that supports multi-band cells for the concerned RAT considers the dedicated priorities to be common for all overlapping bands (i.e., regardless of the ARFCN that is used). The idleModeMobilityControlInfo IE may control target cell selection/re-selection operation while the UE 102 is in inactive Mode and/or while leaving connected mode.

The field redirectedCarrierInfo indicates a carrier frequency (downlink for FDD) and is used to redirect the UE 102 to an E-UTRA or an inter-RAT carrier frequency, by means of the cell selection while in or upon leaving RRC_CONNECTED, as specified in TS 36.304.

The field systemInformation is a container for system information of the GERAN cell. In other words, this is one or more System Information (SI) messages as defined in TS 44.018.

The field t320 is timer T320. Value minN corresponds to N minutes.

The field utra-BCCH-Container contains a System Information Container message as defined in TS 25.331.

A SystemInformationBlockType3 information element is also described. The IE SystemInformationBlockType3 contains cell re-selection information common for intra-frequency, inter-frequency and/or inter-RAT cell re-selection (i.e., applicable for more than one type of cell re-selection but not necessarily all) as well as intra-frequency cell re-selection information other than neighboring cell related. An example of the SystemInformationBlockType3 information element is provided in Listing-7.

Listing-7

| -- ASN1START | | |
|---|---|---|
| SystemInformationBlockType3 ::= | SEQUENCE { | |
| cellReselectionInfoCommon | SEQUENCE { | |
| q-Hyst | ENUMERATED { | |
| | dB0, dB1, dB2, dB3, dB4, dB5, | |
| | dB6, dB8, dB10, dB12, dB14, | |
| | dB16, dB18, dB20, dB22, dB24}, | |
| speedStateReselectionPars | SEQUENCE { | |
| mobilityStateParameters | MobilityStateParameters, | |
| q-HystSF | SEQUENCE { | |
| sf-Medium | ENUMERATED { | |
| | dB-6, dB-4, dB-2, dB0}, | |
| sf-High | ENUMERATED { | |
| | dB-6, dB-4, dB-2, dB0} | |
| } | | |
| } | OPTIONAL | -- Need OP |
| }, | | |
| cellReselectionServingFreqInfo | SEQUENCE { | |
| s-NonIntraSearch | ReselectionThreshold | |
| OPTIONAL, -- Need OP | | |
| threshServingLow | ReselectionThreshold, | |
| cellReselectionPriority | CellReselectionPriority | |
| }, | | |
| intraFreqCellReselectionInfo | SEQUENCE { | |
| q-RxLevMin | Q-RxLevMin, | |
| p-Max | P-Max OPTIONAL, | -- Need OP |
| s-IntraSearch | ReselectionThreshold | |
| OPTIONAL, -- Need OP | | |
| allowedMeasBandwidth | AllowedMeasBandwidth | |
| OPTIONAL, -- Need OP | | |
| presenceAntennaPort1 | PresenceAntennaPort1, | |
| neighCellConfig | NeighCellConfig, | |
| t-ReselectionEUTRA | T-Reselection, | |
| t-ReselectionEUTRA-SF | SpeedStateScaleFactors | |
| OPTIONAL -- Need OP | | |
| }, | | |
| ..., | | |
| lateNonCriticalExtension | OCTET STRING (CONTAINING | |
| SystemInformationBlockType3-v10j0-IEs) | OPTIONAL, | |
| [[ s-IntraSearch-v920 | SEQUENCE { | |
| s-IntraSearchP-r9 | ReselectionThreshold, | |
| s-IntraSearchQ-r9 | ReselectionThresholdQ-r9 | |
| } | OPTIONAL, | -- Need OP |
| s-NonIntraSearch-v920 | SEQUENCE { | |
| s-NonIntraSearchP-r9 | ReselectionThreshold, | |
| s-NonIntraSearchQ-r9 | ReselectionThresholdQ-r9 | |
| } | OPTIONAL, | -- Need OP |

| | |
|---|---|
| q-QualMin-r9 | Q-QualMin-r9 |
| OPTIONAL, -- Need OP | |
| threshServingLowQ-r9 | ReselectionThresholdQ-r9 |
| OPTIONAL -- Need OP | |
| ]], | |
| [[ q-QualMinWB-r11 | Q-QualMin-r9 |
| OPTIONAL -- Cond WB-RSRQ | |
| ]], | |
| [[ q-QualMinRSRQ-OnAllSymbols-r12 | Q-QualMin-r9 |
| OPTIONAL -- Cond RSRQ | |
| ]], | |
| [[ cellReselectionServingFreqInfo-v1310 | |

CellReselectionServingFreqInfo-v1310 OPTIONAL, -- Need OP
redistributionServingInfo-r13

| | |
|---|---|
| RedistributionServingInfo-r13 OPTIONAL, | --Need OR |
| cellSelectionInfoCE-r13 | CellSelectionInfoCE-r13 |
| OPTIONAL, -- Need OP | |

| | |
|---|---|
| t-ReselectionEUTRA-CE-r13 | T-ReselectionEUTRA-CE-r13 |
| OPTIONAL -- Need OP | |
| ]] | |
| } | |
| RedistributionServingInfo-r13 ::= | SEQUENCE { |
| redistributionFactorServing-r13 | INTEGER(0..10), |

| | |
|---|---|
| redistributionFactorCell-r13 | ENUMERATED{true} |
| OPTIONAL, --Need OP | |

| | |
|---|---|
| t360-r13 | ENUMERATED {min4, min8, min16, |

min32,infinity,

spare3,spare2,spare1},

| | |
|---|---|
| redistrOnPagingOnly-r13 | ENUMERATED {true} OPTIONAL --Need OP |
| } | |

```
CellReselectionServingFreqInfo-v1310 ::= SEQUENCE {
    cellReselectionSubPriority-r13
    CellReselectionSubPriority-r13
}
-- Late non critical extensions
SystemInformationBlockType3-v10j0-IEs ::= SEQUENCE {
```

| | |
|---|---|
| freqBandInfo-r10 | NS-PmaxList-r10 |
| OPTIONAL, -- Need OR | |

| | |
|---|---|
| multiBandInfoList-v10j0 | MultiBandInfoList-v10j0 |
| OPTIONAL, -- Need OR | |

| | | |
|---|---|---|
| nonCriticalExtension | SEQUENCE { } | OPTIONAL |
| } | | |
| -- ASN1STOP | | |

If the field allowedMeasBandwidth is absent, the value corresponding to the downlink bandwidth indicated by the dl-Bandwidth included in MasterInformationBlock applies.

The field cellSelectionInfoCE indicates parameters included in coverage enhancement S criteria. They may be used by the UE 102 to select/reselect a cell in which it works in CE mode on the concerned non serving frequency. If absent, the UE 102 acquires the information from the target cell on the concerned frequency.

The field cellReselectionInfoCommon includes cell re-selection information common for cells.

The field cellReselectionServingFreqInfo includes information common for cell re-selection to inter-frequency and inter-RAT cells.

The field freqBandInfo includes a list of additionalPmax and additionalSpectrumEmission values as defined in TS 36.101 applicable for the intra-frequency neighboring E-UTRA cells if the UE 102 selects the frequency band from freqBandIndicator in SystemInformationBlockType1.

The field intraFreqcellReselectionInfo includes cell re-selection information common for intra-frequency cells.

The field multiBandInfoList-v10j0 includes a list of additionalPmax and additionalSpectrumEmission values as defined in TS 36.101 applicable for the intra-frequency neighboring E-UTRA cells if the UE 102 selects the frequency bands in multiBandInfoList (i.e. without suffix) or multiBandInfoList-v9e0. If E-UTRAN includes multiBandInfoList-v10j0, it includes the same number of entries, and listed in the same order, as in multiBandInfoList (i.e. without suffix).

The field p-Max is a value applicable for the intra-frequency neighboring E-UTRA cells. If absent the UE 102 applies the maximum power according to the UE capability.

If the field redistrOnPagingOnly is present and the UE 102 is redistribution capable, the UE 102 shall only wait for the paging message to trigger E-UTRAN inter-frequency redistribution procedure as specified in 5.2.4.10 of TS 36.304.

The field q-Hyst is the parameter Q_{hyst} in TS 36.304, where the value is in dB. Value dB1 corresponds to 1 dB, dB2 corresponds to 2 dB and so on.

The field q-HystSF is the parameter “Speed dependent ScalingFactor for Q_{hyst}” in TS 36.304. The sf-Medium and sf-High concern the additional hysteresis to be applied, in Medium and High Mobility state respectively, to Q_{hyst} as defined in TS 36.304. The value is in dB. A value dB-6 corresponds to −6 dB, dB-4 corresponds to −4 dB and so on.

The field q-QualMin is the parameter “Q_{qualmin}” in TS 36.304, applicable for intra-frequency neighbor cells. If the field is not present, the UE 102 applies the (default) value of negative infinity for Q_{qualmin}.

If the field q-QualMinRSRQ-OnAllSymbols is present and supported by the UE 102, the UE 102 shall, when performing RSRQ measurements, perform RSRQ measurement on all Orthogonal frequency-division multiplexing (OFDM) symbols in accordance with TS 36.214.

If the field q-QualMinWB is present and supported by the UE 102, the UE 102 shall, when performing RSRQ measurements, use a wider bandwidth in accordance with TS 36.133.

The field q-RxLevMin is a parameter “Qᵣₓₗₑᵥₘᵢₙ” in TS 36.304, applicable for intra-frequency neighbor cells.

If the field redistributionFactorCell is present, redistributionFactorServing is only applicable for the serving cell otherwise it is applicable for serving frequency.

The field redistributionFactorServing is a parameter redistributionFactorServing in TS 36.304.

The field s-IntraSearch is a parameter “S_{IntraSearchP}” in TS 36.304. If the field s-IntraSearchP is present, the UE 102 applies the value of s-IntraSearchP instead. Otherwise if neither s-IntraSearch nor s-IntraSearchP is present, the UE 102 applies the (default) value of infinity for S_{IntraSearchP}.

The field s-IntraSearchP is a parameter “S_{IntraSearchP}” in TS 36.304, as described in s-IntraSearch.

The field s-IntraSearchQ is a parameter “S_{IntraSearchQ}” in TS 36.304. If the field is not present, the UE 102 may apply the (default) value of 0 dB for S_{IntraSearchQ}.

The field s-NonIntraSearch is a parameter “S_{nonIntraSearchP}” in TS 36.304. If the field s-NonIntraSearchP is present, the UE 102 applies the value of s-NonIntraSearchP instead. Otherwise if neither s-NonIntraSearch nor s-NonIntraSearchP is present, the UE 102 applies the (default) value of infinity for S_{nonIntraSearchP}.

The field s-NonIntraSearchP is a parameter “S_{nonIntraSearchP}” in TS 36.304. See the description under s-NonIntraSearch.

The field s-NonIntraSearchQ is a parameter “S_{nonIntraSearchQ}” in TS 36.304. If the field s-NonIntraSearchQ is not present, the UE 102 applies the (default) value of 0 dB for S_{nonIntraSearchQ}.

The field speedStateReselectionPars includes speed dependent reselection parameters. If this field is absent (i.e., mobilityStateParameters is also not present), UE behavior is specified in TS 36.304.

The field t360 is parameter “T360” in TS 36.304. The value min4 corresponds to 4 minutes, value min8 corresponds to 8 minutes, and so on.

The field threshServingLow is parameter “ThreshServing, LowP” in TS 36.304.

The field threshServingLowQ is parameter “ThreshServing, LowQ” in TS 36.304.

The field t-ReselectionEUTRA is parameter “TreselectionEUTRA” in TS 36.304.

The field t-ReselectionEUTRA-SF is parameter “Speed dependent ScalingFactor for TreselectionEUTRA” in TS 36.304. If the field is not present, the UE behavior is specified in TS 36.304.

The UE operations module 124 may provide information 148 to the one or more receivers 120. For example, the UE operations module 124 may inform the receiver(s) 120 when to receive retransmissions.

The UE operations module 124 may provide information 138 to the demodulator 114. For example, the UE operations module 124 may inform the demodulator 114 of a modulation pattern anticipated for transmissions from the gNB 160.

The UE operations module 124 may provide information 136 to the decoder 108. For example, the UE operations module 124 may inform the decoder 108 of an anticipated encoding for transmissions from the gNB 160.

The UE operations module 124 may provide information 142 to the encoder 150. The information 142 may include data to be encoded and/or instructions for encoding. For example, the UE operations module 124 may instruct the encoder 150 to encode transmission data 146 and/or other information 142. The other information 142 may include PDSCH HARQ-ACK information.

The encoder 150 may encode transmission data 146 and/or other information 142 provided by the UE operations module 124. For example, encoding the data 146 and/or other information 142 may involve error detection and/or correction coding, mapping data to space, time and/or frequency resources for transmission, multiplexing, etc. The encoder 150 may provide encoded data 152 to the modulator 154.

The UE operations module 124 may provide information 144 to the modulator 154. For example, the UE operations module 124 may inform the modulator 154 of a modulation type (e.g., constellation mapping) to be used for transmissions to the gNB 160. The modulator 154 may modulate the encoded data 152 to provide one or more modulated signals 156 to the one or more transmitters 158.

The UE operations module 124 may provide information 140 to the one or more transmitters 158. This information 140 may include instructions for the one or more transmitters 158. For example, the UE operations module 124 may instruct the one or more transmitters 158 when to transmit a signal to the gNB 160. For instance, the one or more transmitters 158 may transmit during an uplink (UL) subframe. The one or more transmitters 158 may upconvert and transmit the modulated signal(s) 156 to one or more gNBs 160.

Each of the one or more gNBs 160 may include one or more transceivers 176, one or more demodulators 172, one or more decoders 166, one or more encoders 109, one or more modulators 113, a data buffer 162 and a gNB operations module 182. For example, one or more reception and/or transmission paths may be implemented in a gNB 160. For convenience, only a single transceiver 176, decoder 166, demodulator 172, encoder 109 and modulator 113 are illustrated in the gNB 160, though multiple parallel elements (e.g., transceivers 176, decoders 166, demodulators 172, encoders 109 and modulators 113) may be implemented.

The transceiver 176 may include one or more receivers 178 and one or more transmitters 117. The one or more receivers 178 may receive signals from the UE 102 using one or more physical antennas 180a-n. For example, the receiver 178 may receive and downconvert signals to produce one or more received signals 174. The one or more received signals 174 may be provided to a demodulator 172. The one or more transmitters 117 may transmit signals to the UE 102 using one or more physical antennas 180a-n. For example, the one or more transmitters 117 may upconvert and transmit one or more modulated signals 115.

The demodulator 172 may demodulate the one or more received signals 174 to produce one or more demodulated signals 170. The one or more demodulated signals 170 may be provided to the decoder 166. The gNB 160 may use the decoder 166 to decode signals. The decoder 166 may produce one or more decoded signals 164, 168. For example, a first eNB-decoded signal 164 may comprise received payload data, which may be stored in a data buffer 162. A second eNB-decoded signal 168 may comprise overhead data and/or control data. For example, the second eNB-decoded signal 168 may provide data (e.g., PDSCH HARQ-ACK information) that may be used by the gNB operations module 182 to perform one or more operations.

In general, the gNB operations module 182 may enable the gNB 160 to communicate with the one or more UEs 102. The gNB operations module 182 may include one or more of a gNB handoff module 194. The gNB handoff module 194 may perform handoff operations as described herein.

The gNB operations module 182 may provide information 188 to the demodulator 172. For example, the gNB operations module 182 may inform the demodulator 172 of a modulation pattern anticipated for transmissions from the UE(s) 102.

The gNB operations module 182 may provide information 186 to the decoder 166. For example, the gNB operations module 182 may inform the decoder 166 of an anticipated encoding for transmissions from the UE(s) 102.

The gNB operations module 182 may provide information 101 to the encoder 109. The information 101 may include data to be encoded and/or instructions for encoding. For example, the gNB operations module 182 may instruct the encoder 109 to encode information 101, including transmission data 105.

The encoder 109 may encode transmission data 105 and/or other information included in the information 101 provided by the gNB operations module 182. For example, encoding the data 105 and/or other information included in the information 101 may involve error detection and/or correction coding, mapping data to space, time and/or frequency resources for transmission, multiplexing, etc. The encoder 109 may provide encoded data 111 to the modulator 113. The transmission data 105 may include network data to be relayed to the UE 102.

The gNB operations module 182 may provide information 103 to the modulator 113. This information 103 may include instructions for the modulator 113. For example, the gNB operations module 182 may inform the modulator 113 of a modulation type (e.g., constellation mapping) to be used for transmissions to the UE(s) 102. The modulator 113 may modulate the encoded data 111 to provide one or more modulated signals 115 to the one or more transmitters 117.

The gNB operations module 182 may provide information 192 to the one or more transmitters 117. This information 192 may include instructions for the one or more transmitters 117. For example, the gNB operations module 182 may instruct the one or more transmitters 117 when to (or when not to) transmit a signal to the UE(s) 102. The one or more transmitters 117 may upconvert and transmit the modulated signal(s) 115 to one or more UEs 102.

It should be noted that a DL subframe may be transmitted from the gNB 160 to one or more UEs 102 and that a UL subframe may be transmitted from one or more UEs 102 to the gNB 160. Furthermore, both the gNB 160 and the one or more UEs 102 may transmit data in a standard special subframe.

It should also be noted that one or more of the elements or parts thereof included in the eNB(s) 160 and UE(s) 102 may be implemented in hardware. For example, one or more of these elements or parts thereof may be implemented as a chip, circuitry or hardware components, etc. It should also be noted that one or more of the functions or methods described herein may be implemented in and/or performed using hardware. For example, one or more of the methods described herein may be implemented in and/or realized using a chipset, an application-specific integrated circuit (ASIC), a large-scale integrated circuit (LSI) or integrated circuit, etc.

FIG. 2 is a call flow diagram illustrating a new cell activation of a UE-based HO feature. The UE 202 and gNB 260 may perform 201 RACH access. The UE 202 may send 203 a UE capability report (i.e., UE-based HO capability) or a rules request to the gNB 260.

In step 205, the gNB 260 may make a determination whether to enable the UE-based HO feature in the UE 202. The gNB 260 may provide a set of rules to guide HO procedures.

In step 207, the gNB 260 may enable or disable UE-based HO with or without the rules.

FIG. 3 is a call flow diagram illustrating a ultra-reliable low latency communication (URLLC) new service activation of UE-based HO. In step 301, the UE 302 and gNB 360 may perform RACH access. This may include a new service indication.

In step 303, the gNB 360 may send the UE 302 a UE capability request. This may include a request for UE-based HO.

In step 305, the UE 302 may send a UE capability report. This report may include the UE-based HO capability.

In step 307, the gNB 360 may make a determination whether to enable the UE-based HO feature in the UE 302. The gNB 360 may provide a set of rules on operator preferences.

In step 309, the gNB 360 may enable or disable UE-based HO. The gNB 360 may (optionally) send the set of rules.

In step 311, the NR UE 302 may monitor the high priority cells according to the rules (optional). The UE 302 may decide on the best candidates according to pre-configured criteria.

FIG. 4 is a call flow diagram illustrating area activation of a UE-based HO feature using NAS signaling. In step 401, the UE 402 and a gNB 460 may perform an initial attach. This may include a RACH procedure.

In step 403, the gNB 460 may send an attach request to a 4G/5G Mobility Management Entity (MME) 404. The attach request may request a UE-based HO capability. In step 405, the MME 404 may determine whether to allow UE-based mobility.

In step 407, the MME 404 may send a Radio Access Bearer (RAB) configuration to the gNB 460. The RAB configuration may indicate that UE-based HO is enabled.

In step 409, the gNB 460 may enable the UE-based HO feature. In step 411, the gNB 460 may send a RAB configuration to the UE 402. The RAB configuration may enable the UE-based HO feature. The gNB 460 may include HO rules and a list of preferred targets.

FIG. 5 is a call flow diagram illustrating de-activation of UE-based HO feature in the case of NR to LTE inter-RAT HO. In step 501, the UE 502 may be initially connected over NR. In step 503, the UE-based HO is active. At some point, the UE 502 may decide to HO to LTE.

In a first alternative (Alt 1), the UE 502 may send (Step 505) a HO request to the gNB 560. In step 507, the gNB 560 may send the HO request to the NG core 510.

In a second alternative (Alt 2), the UE 502 accesses (Step 509) LTE with a Physical Random Access Channel (PRACH) procedure. In step 511, the UE 502 may send the HO request to an eNB 506, which sends (Step 513) the HO request to an Evolved Packet Core (EPC) 508. In step 515, the EPC 508 sends the HO to the NG core 510.

In step 517, the NG core 510 may convert the HO request to an EPC context. In step 519, the NG core 510 may transfer the context to the EPC 508. In step 521, the EPC 508 may send the HO request to the eNB 506. The HO request may include a UE 51 context including Evolved Packet System (EPS) bearers.

In the first alternative (Alt 1), the eNB 506 issues (step 525) an HO command based on the UE context and DRBs to be setup. In the second alternative (Alt 2), the eNB 506 sends (step 523) an HO command to the UE 502 that includes a deactivation of the UE-based HO.

In step 527, the eNB 506 may send an HO request Ack to the EPC 508. The EPC 508 may send a handoff Ack to the NG core 510.

In the first alternative (Alt 1), the NG core 510 may send (step 531) an HO command to the gNB 560. In step 533, the gNB 560 may send the HO command to the UE 502 that includes deactivation of the UE-based HO.

In step 535, the UE 502 may access LTE (e.g., eNB 506) with the configuration and DRBs in the HO.

FIG. 6 is a call flow diagram illustrating a UE capability transfer. The E-UTRAN 612 may send (step 601) a UECapabilityEnquiry to the UE 601. The UE 602 may respond (step 603) by sending a UECapabilityInformation message.

FIG. 7 illustrates network (NW) controlled mobility and UE controlled mobility schemes. These examples show a range or mobility schemes from UE-centric to NW-centric.

A first example (a) is UE controlled mobility with a tracking area. This may occur in an IDLE state.

A second example (b) is UE controlled mobility with a RAN area. This may occur in an INACTIVE state.

A third example (c) is NW controlled mobility with UE-based selection. This may occur in a CONNECTED state.

A fourth example (d) is NW controlled HO with condition make-before-break. This may occur in a CONNECTED state.

A fifth example (e) is NW controlled HO. This may occur in a CONNECTED state.

FIG. 8 illustrates examples of a NW controlled secondary cell group (SCG) change. A first example (a) depicts a NW controlled SCG change with UE-based selection. A second example (b) depicts a NW controlled SCG change with condition make-before-break. A third example (c) depicts a NW controlled SCG change.

FIGS. 9A and 9B are a call flow diagram illustrating active mode mobility in LTE. In particular, the HO procedure used in LTE is depicted in FIG. 9A and FIG. 9B.

FIG. 10 is a call flow diagram illustrating a baseline HO procedure for NR.

FIG. 11 is a call flow diagram illustrating conditional handoff execution based on DL RS measurements.

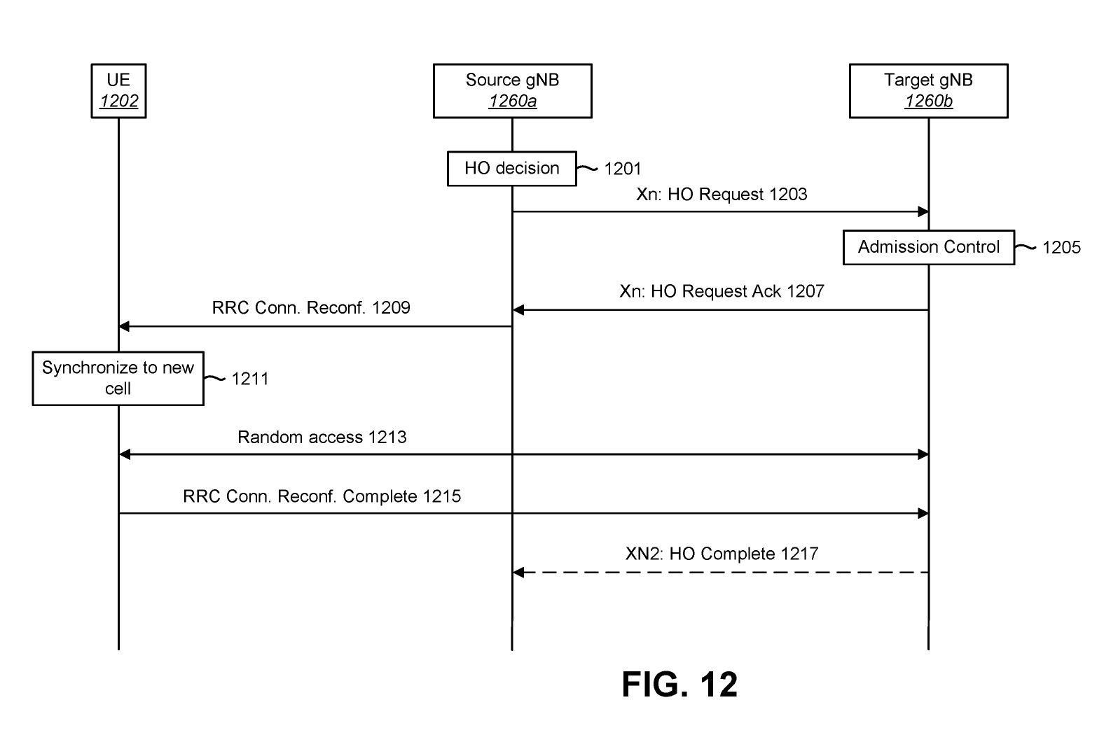

FIG. 12 is a call flow diagram illustrating a HO procedure to establish a link at the target gNB 1260b after a mobility trigger has occurred. In step 1201, the source gNB 1260a may make the HO decision (i.e., mobility trigger) based on measurements. In step 1203, the source gNB 1260a may send an HO request to the target gNB 1260b on the Xn interface.

In step 1205, the target gNB 1260b may perform admission control. In step 1207, the target gNB 1260b may send an HO request acknowledgement (Ack) to the source gNB 1260a over the Xn interface. The target gNB 1260b may provide the RRC configuration as part of the HO acknowledgement.

In step 1209, the source gNB 1260a may send an RRC connection reconfiguration to the UE 1202. The source gNB 1260a provides the configuration to the UE 1202 including the HO command equivalent via RR.

In step 1211, the UE 1202 may synchronize to the new cell. In step 1213, the UE 1202 may perform random access with the target gNB 1260b. In step 1215, the UE 1202 may send a Radio Resource Control (RRC) connection reconfiguration complete to the target gNB 1260b. In step 1217, the target gNB 1260b may send an HO complete message to the source gNB 1260a on the Xn2 interface.

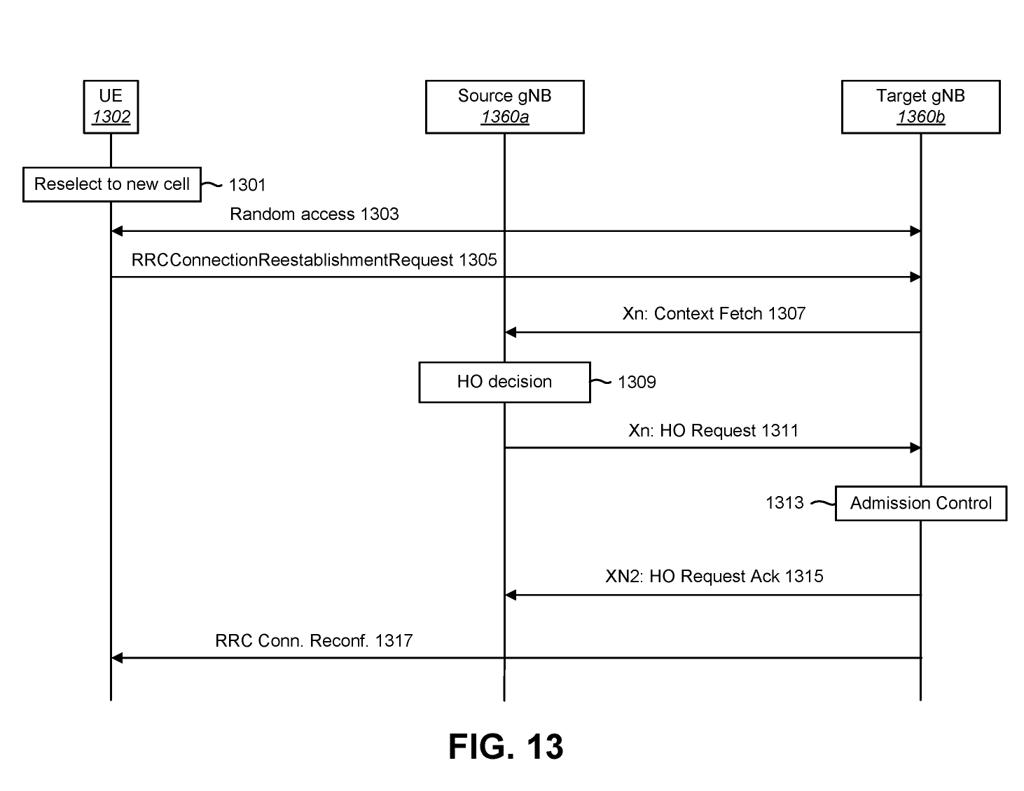

FIG. 13 is a call flow diagram illustrating a context fetch procedure to establish a link at the target gNB 1360b after the mobility trigger has occurred. The mobility trigger may occur at the UE-based on reselection or selection after Radio Link Failure (RLF). In step 1301, the UE 1302 may determine to reselect to the new cell.

In step 1303, the UE 1302 may establish a connection at the target gNB 1360b via RRC. The UE 1302 may perform a random access with the target gNB 1360b. In step 1305, the UE 1302 may send an RRC connection reestablishment request to the target gNB 1360b.

In step 1307, the target gNB 1360b may indicate to the source gNB 1360a that the UE 1302 has established a connection. The target gNB 1360b and source gNB 1360a may transfer the UE context via Xn. For example, the target gNB 1360b may send a context fetch to the source gNB 1360a on the Xn interface.

In step 1309, the source gNB 1360a may perform an HO decision. In step 1311, the source gNB 1360a may send an HO request to the target gNB 1360b on the Xn interface. In step 1313, the target gNB 1360b may perform admission control. In step 1315, the target gNB 1360b may send an HO request acknowledgement (Ack) to the source gNB 1360a over the Xn2 interface.

In step 1317, the target gNB 1360b may reconfigure the UE 1302 via RRC. For example, the target gNB 1360b may send an RRC connection reconfiguration to the UE 1302.

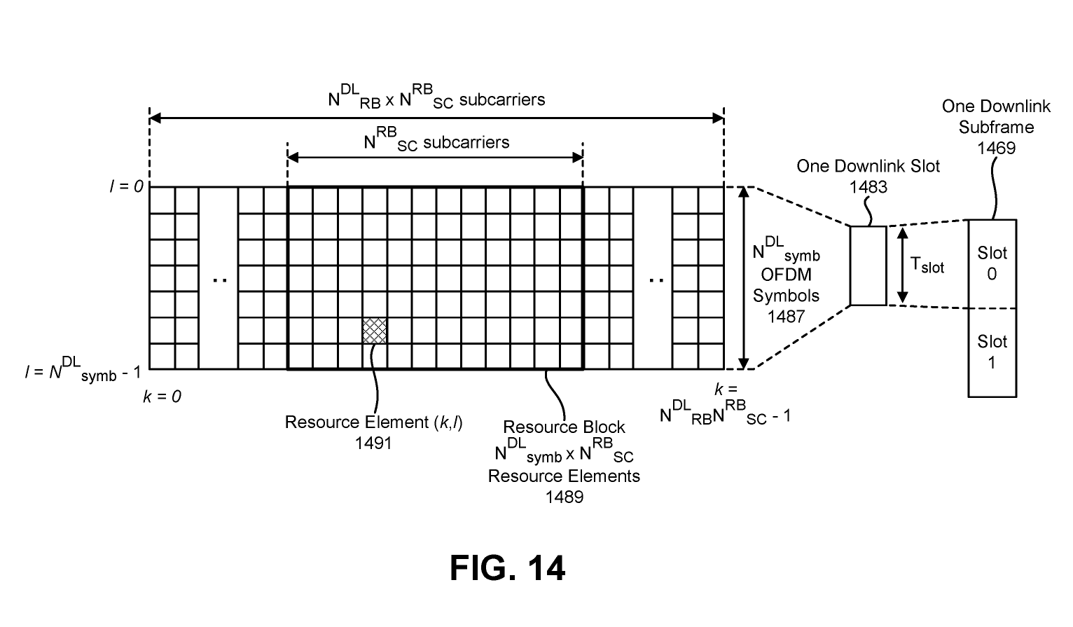

FIG. 14 is a diagram illustrating one example of a resource grid for the downlink. The resource grid illustrated in FIG. 14 may be utilized in some implementations of the systems and methods disclosed herein. More detail regarding the resource grid is given in connection with FIG. 1.

In FIG. 14, one downlink subframe 1469 may include two downlink slots 1483. N^{DL}_{RB} is downlink bandwidth configuration of the serving cell, expressed in multiples of N^{RB}_{sc}, where N^{RB}_{sc} is a resource block 1489 size in the frequency domain expressed as a number of subcarriers, and N^{DL}_{symb} is the number of OFDM symbols 1487 in a downlink slot 1483. A resource block 1489 may include a number of resource elements (RE) 1491.

For a PCell, N^{DL}_{RB} is broadcast as a part of system information. For an SCell (including an Licensed Assisted Access (LAA) SCell), N^{DL}_{RB} is configured by a RRC message dedicated to a UE 102. For PDSCH mapping, the available RE 1491 may be the RE 1491 whose index l fulfils l≥l_{data,start} and/or l_{data,end}≥l in a subframe.

In the downlink, the OFDM access scheme with cyclic prefix (CP) may be employed, which may be also referred to as CP-OFDM. In the downlink, PDCCH, EPDCCH, PDSCH and the like may be transmitted. A downlink radio frame may include multiple pairs of downlink resource blocks (RBs) which is also referred to as physical resource blocks (PRBs). The downlink RB pair is a unit for assigning downlink radio resources, defined by a predetermined bandwidth (RB bandwidth) and a time slot. The downlink RB pair includes two downlink RBs that are continuous in the time domain.

The downlink RB includes twelve sub-carriers in frequency domain and seven (for normal CP) or six (for extended CP) OFDM symbols in time domain. A region defined by one sub-carrier in frequency domain and one OFDM symbol in time domain is referred to as a resource element (RE) and is uniquely identified by the index pair (k,l) in a slot, where k and l are indices in the frequency and time domains, respectively. While downlink subframes in one component carrier (CC) are discussed herein, downlink subframes are defined for each CC and downlink subframes are substantially in synchronization with each other among CCs.

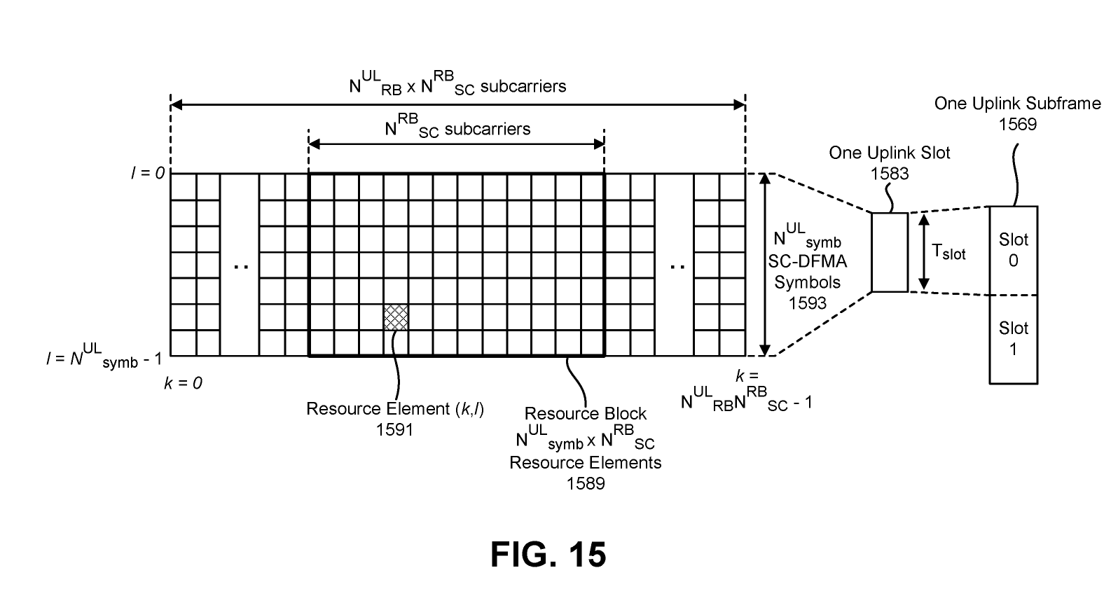

FIG. 15 is a diagram illustrating one example of a resource grid for the uplink. The resource grid illustrated in FIG. 15 may be utilized in some implementations of the systems and methods disclosed herein. More detail regarding the resource grid is given in connection with FIG. 1.

In FIG. 15, one uplink subframe 1569 may include two uplink slots 1583. N^{UL}_{RB} is uplink bandwidth configuration of the serving cell, expressed in multiples of N^{RB}_{sc}, where N^{RB}_{sc} is a resource block 1589 size in the frequency domain expressed as a number of subcarriers, and N^{UL}_{symb} is the number of SC-FDMA symbols 1593 in an uplink slot 1583. A resource block 1589 may include a number of resource elements (RE) 1591.

For a PCell, N^{UL}_{RB} is broadcast as a part of system information. For an SCell (including an LAA SCell), N^{UL}_{RB} is configured by a RRC message dedicated to a UE 102.

In the uplink, in addition to CP-OFDM, a Single-Carrier Frequency Division Multiple Access (SC-FDMA) access scheme may be employed, which is also referred to as Discrete Fourier Transform-Spreading OFDM (DFT-S-OFDM). In the uplink, PUCCH, PDSCH, PRACH and the like may be transmitted. An uplink radio frame may include multiple pairs of uplink resource blocks. The uplink RB pair is a unit for assigning uplink radio resources, defined by a predetermined bandwidth (RB bandwidth) and a time slot. The uplink RB pair includes two uplink RBs that are continuous in the time domain.

The uplink RB may include twelve sub-carriers in frequency domain and seven (for normal CP) or six (for extended CP) OFDM/DFT-S-OFDM symbols in time domain. A region defined by one sub-carrier in the frequency domain and one OFDM/DFT-S-OFDM symbol in the time domain is referred to as a RE and is uniquely identified by the index pair (k,l) in a slot, where k and l are indices in the frequency and time domains respectively. While uplink subframes in one component carrier (CC) are discussed herein, uplink subframes are defined for each CC.

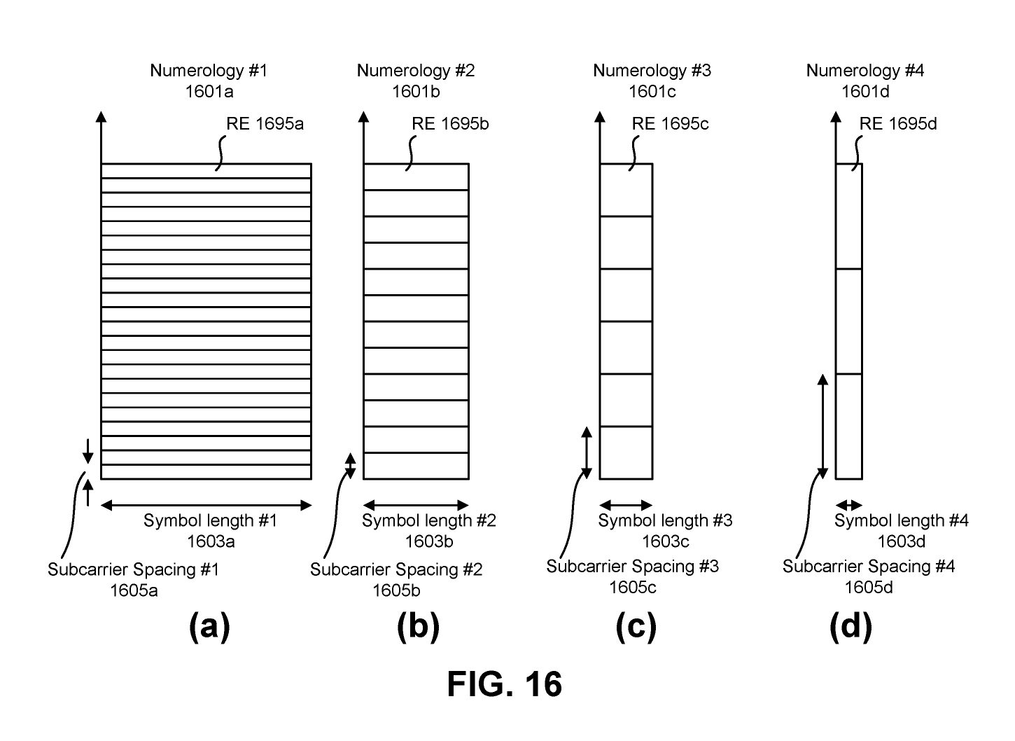

FIG. 16 shows examples of several numerologies 1601. The numerology #1 1601a may be a basic numerology (e.g., a reference numerology). For example, a RE 1695a of the basic numerology 1601a may be defined with subcarrier spacing 1605a of 15 kHz in frequency domain and 2048 Ts+CP length (e.g., 160 Ts or 164 Ts) in time domain (i.e., symbol length #1 1603a), where Ts denotes a baseband sampling time unit defined as 1/(15000*2048) seconds. For the i-th numerology, the subcarrier spacing 1605 may be equal to 15*2ⁱ and the effective OFDM symbol length 2048*2⁻ⁱ*Ts. It may cause the symbol length is 2048*2⁻ⁱ*Ts+CP length (e.g., 160*2⁻ⁱ*Ts or 164*2⁻ⁱ*Ts). In other words, the subcarrier spacing of the i+1-th numerology is a double of the one for the i-th numerology, and the symbol length of the i+1-th numerology is a half of the one for the i-th numerology. FIG. 16 shows four numerologies, but the system may support another number of numerologies. Furthermore, the system does not have to support all of the 0-th to the I-th numerologies, i=0, 1, . . . , I.

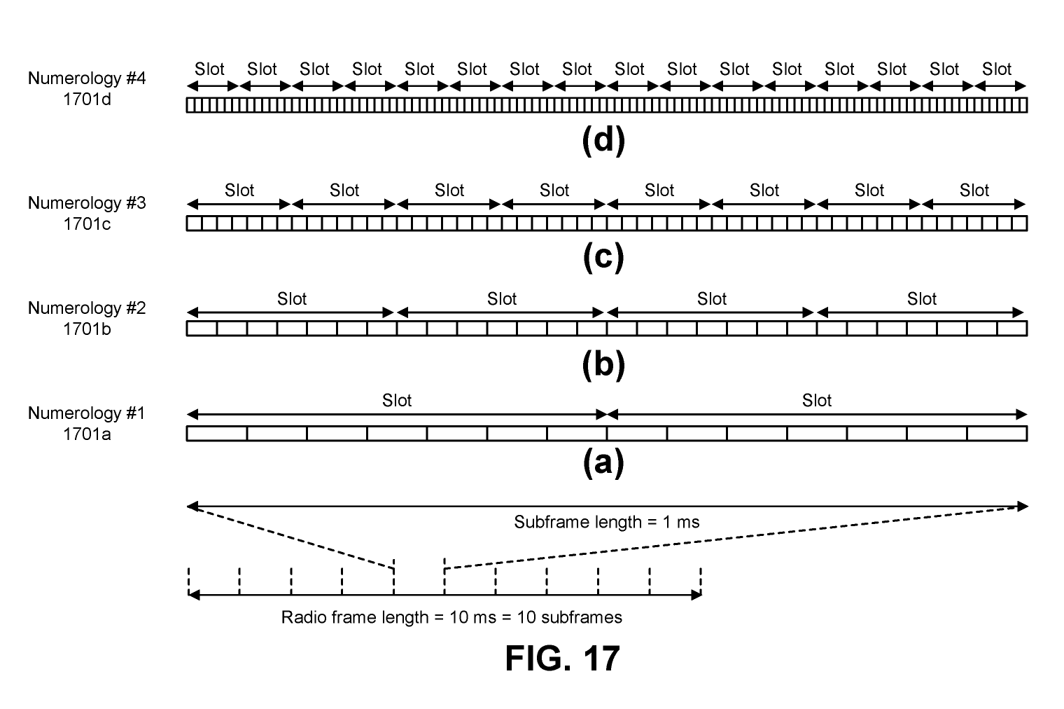

FIG. 17 shows examples of subframe structures for the numerologies 1701 that are shown in FIG. 16. Given that a slot 283 includes N^{DL}_{symb} (or N^{UL}_{symb})=7 symbols, the slot length of the i+1-th numerology 1701 is a half of the one for the i-th numerology 1701, and eventually the number of slots 283 in a subframe (i.e., 1 ms) becomes double. It may be noted that a radio frame may include 10 subframes, and the radio frame length may be equal to 10 ms.

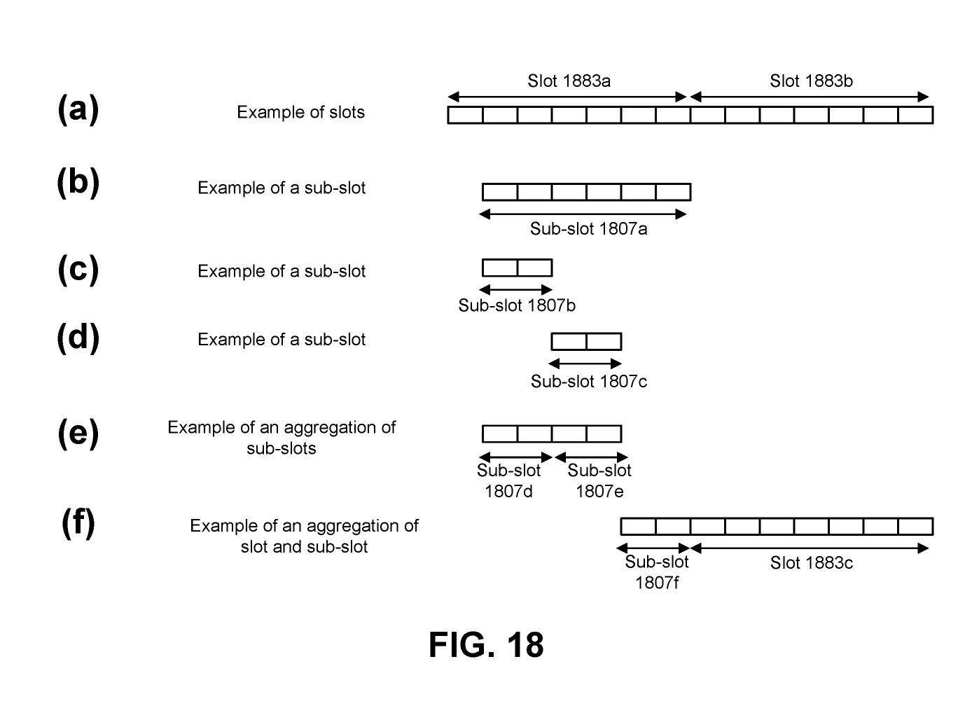

FIG. 18 shows examples of slots 1883 and sub-slots 1807. If a sub-slot 1807 is not configured by higher layer, the UE 102 and the eNB/gNB 160 may only use a slot 1883 as a scheduling unit. More specifically, a given transport block may be allocated to a slot 1883. If the sub-slot 1807 is configured by higher layer, the UE 102 and the eNB/gNB 160 may use the sub-slot 1807 as well as the slot 1883. The sub-slot 1807 may include one or more OFDM symbols. The maximum number of OFDM symbols that constitute the sub-slot 1807 may be N^{DL}_{symb}−1 (or N^{UL}_{symb}−1).

The sub-slot length may be configured by higher layer signaling. Alternatively, the sub-slot length may be indicated by a physical layer control channel (e.g., by Downlink Control Information (DCI) format).

The sub-slot 1807 may start at any symbol within a slot 1883 unless it collides with a control channel. There could be restrictions of mini-slot length based on restrictions on starting position. For example, the sub-slot 1807 with the length of N^{DL}_{symb}−1 (or N^{UL}_{symb}−1) may start at the second symbol in a slot 1883. The starting position of a sub-slot 1807 may be indicated by a physical layer control channel (e.g., by DCI format). Alternatively, the starting position of a sub-slot 1807 may be derived from information (e.g., search space index, blind decoding candidate index, frequency and/or time resource indices, PRB index, a control channel element index, control channel element aggregation level, an antenna port index, etc.) of the physical layer control channel which schedules the data in the concerned sub-slot 1807.

In cases when the sub-slot 1807 is configured, a given transport block may be allocated to either a slot 1883, a sub-slot 1807, aggregated sub-slots 1807 or aggregated sub-slot(s) 1807 and slot 1883. This unit may also be a unit for HARQ-ACK bit generation.

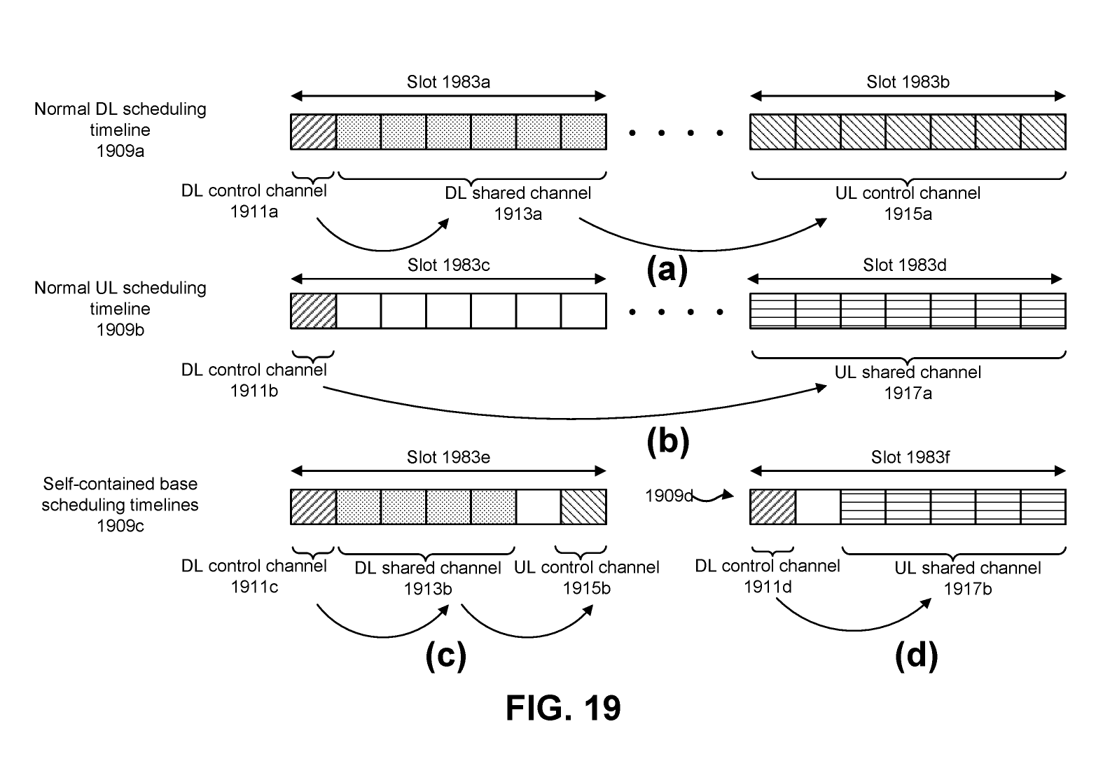

FIG. 19 shows examples of scheduling timelines 1909. For a normal DL scheduling timeline 1909a, DL control channels are mapped the initial part of a slot 1983a. The DL control channels 1911 schedule DL shared channels 1913a in the same slot 1983a. HARQ-ACKs for the DL shared channels 1913a (i.e., HARQ-ACKs each of which indicates whether or not transport block in each DL shared channel 1913a is detected successfully) are reported via UL control channels 1915a in a later slot 1983b. In this instance, a given slot 1983 may contain either one of DL transmission and UL transmission.

For a normal UL scheduling timeline 1909b, DL control channels 1911b are mapped the initial part of a slot 1983c. The DL control channels 1911b schedule UL shared channels 1917a in a later slot 1983d. For these cases, the association timing (time shift) between the DL slot 1983c and the UL slot 1983d may be fixed or configured by higher layer signaling. Alternatively, it may be indicated by a physical layer control channel (e.g., the DL assignment DCI format, the UL grant DCI format, or another DCI format such as UE-common signaling DCI format which may be monitored in common search space).

For a self-contained base DL scheduling timeline 1909c, DL control channels 1911c are mapped to the initial part of a slot 1983e. The DL control channels 1911c schedule DL shared channels 1913b in the same slot 1983e. HARQ-ACKs for the DL shared channels 1913b are reported in UL control channels 1915b, which are mapped at the ending part of the slot 1983e.

For a self-contained base UL scheduling timeline 1909d, DL control channels 1911d are mapped to the initial part of a slot 1983f. The DL control channels 1911d schedule UL shared channels 1917b in the same slot 1983f. For these cases, the slot 1983f may contain DL and UL portions, and there may be a guard period between the DL and UL transmissions.

The use of a self-contained slot may be upon a configuration of self-contained slot. Alternatively, the use of a self-contained slot may be upon a configuration of the sub-slot. Yet alternatively, the use of a self-contained slot may be upon a configuration of shortened physical channel (e.g., PDSCH, PUSCH, PUCCH, etc.).

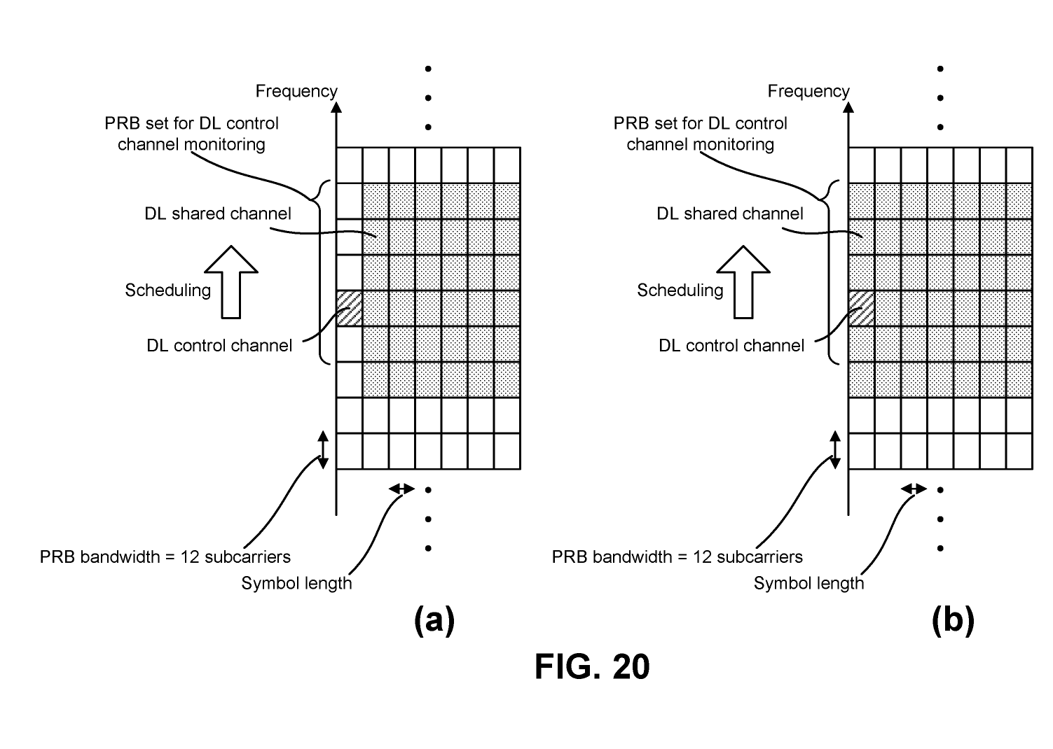

FIG. 20 shows examples of DL control channel monitoring regions. One or more sets of PRB(s) may be configured for DL control channel monitoring. In other words, a control resource set is, in the frequency domain, a set of PRBs within which the UE 102 attempts to blindly decode downlink control information, where the PRBs may or may not be frequency contiguous, a UE 102 may have one or more control resource sets, and one DCI message may be located within one control resource set. In the frequency-domain, a PRB is the resource unit size (which may or may not include demodulation reference signals (DM-RS)) for a control channel. A DL shared channel may start at a later OFDM symbol than the one(s) which carries the detected DL control channel. Alternatively, the DL shared channel may start at (or earlier than) an OFDM symbol than the last OFDM symbol which carries the detected DL control channel. In other words, dynamic reuse of at least part of resources in the control resource sets for data for the same or a different UE 102, at least in the frequency domain may be supported.

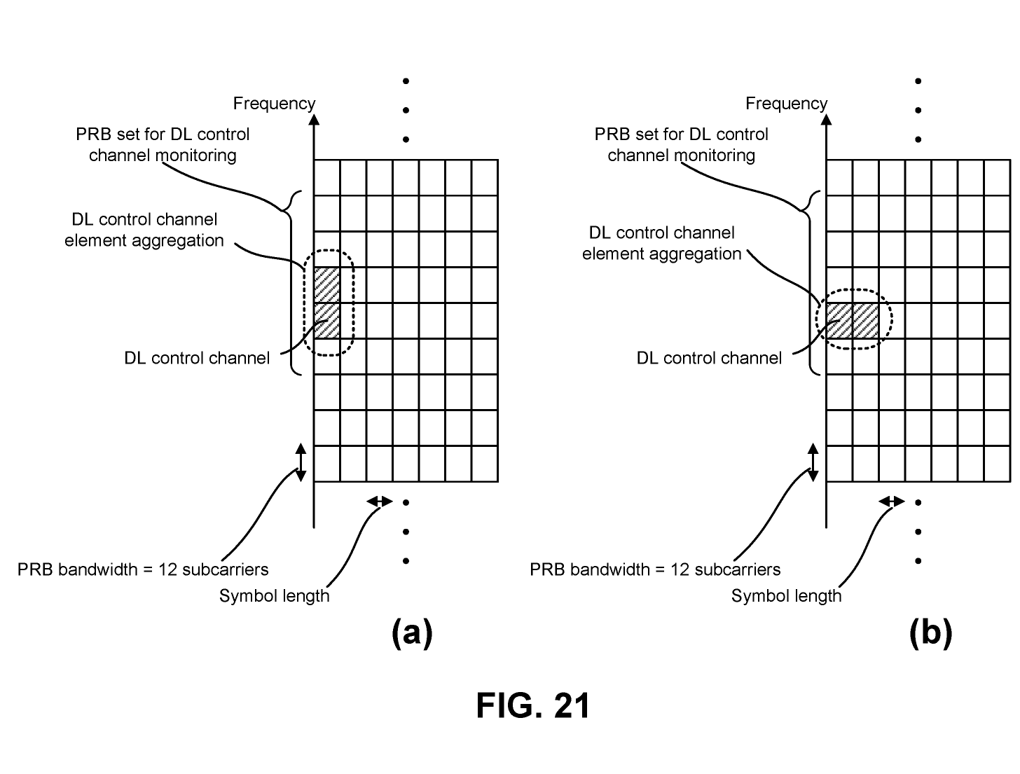

FIG. 21 shows examples of DL control channel which includes more than one control channel elements. When the control resource set spans multiple OFDM symbols, a control channel candidate may be mapped to multiple OFDM symbols or may be mapped to a single OFDM symbol. One DL control channel element may be mapped on REs defined by a single PRB and a single OFDM symbol. If more than one DL control channel elements are used for a single DL control channel transmission, DL control channel element aggregation may be performed.

The number of aggregated DL control channel elements is referred to as DL control channel element aggregation level. The DL control channel element aggregation level may be 1 or 2 to the power of an integer. The gNB 160 may inform a UE 102 of which control channel candidates are mapped to each subset of OFDM symbols in the control resource set. If one DL control channel is mapped to a single OFDM symbol and does not span multiple OFDM symbols, the DL control channel element aggregation is performed within an OFDM symbol, namely multiple DL control channel elements within an OFDM symbol are aggregated. Otherwise, DL control channel elements in different OFDM symbols can be aggregated.

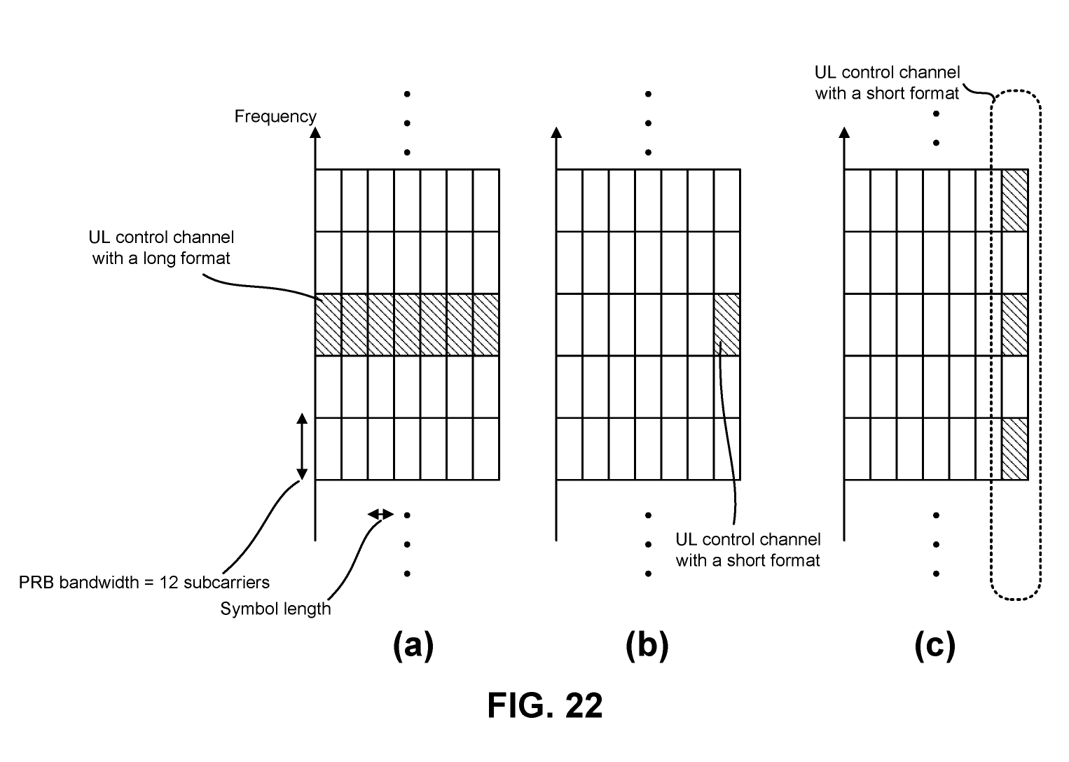

FIG. 22 shows examples of UL control channel structures. UL control channel may be mapped on REs which are defined a PRB and a slot in frequency and time domains, respectively. This UL control channel may be referred to as a long format (or just the 1st format). UL control channels may be mapped on REs on a limited OFDM symbols in time domain. This may be referred to as a short format (or just the 2nd format). The UL control channels with a short format may be mapped on REs within a single PRB. Alternatively, the UL control channels with a short format may be mapped on REs within multiple PRBs. For example, interlaced mapping may be applied, namely the UL control channel may be mapped to every N PRBs (e.g. 5 or 10) within a system bandwidth.

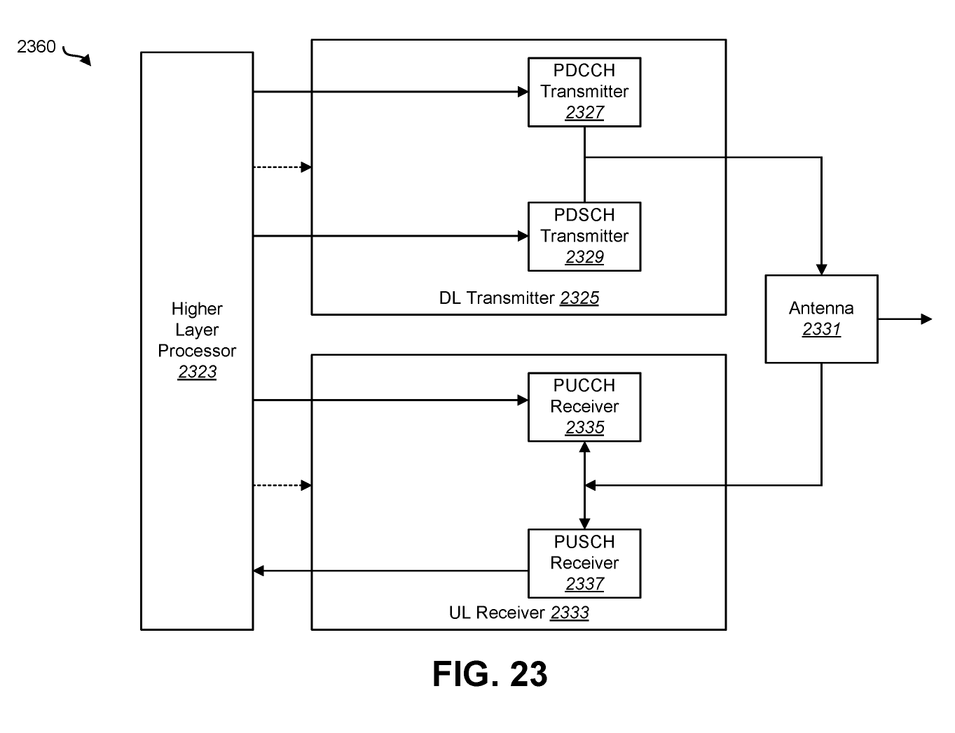

FIG. 23 is a block diagram illustrating one implementation of a gNB 2360. The gNB 2360 may include a higher layer processor 2323, a DL transmitter 2325, a UL receiver 2333, and one or more antenna 2331. The DL transmitter 2325 may include a PDCCH transmitter 2327 and a PDSCH transmitter 2329. The UL receiver 2333 may include a PUCCH receiver 2335 and a PUSCH receiver 2337.

The higher layer processor 2323 may manage physical layer's behaviors (the DL transmitter's and the UL receiver's behaviors) and provide higher layer parameters to the physical layer. The higher layer processor 2323 may obtain transport blocks from the physical layer. The higher layer processor 2323 may send/acquire higher layer messages such as an RRC message and MAC message to/from a UE's higher layer. The higher layer processor 2323 may provide the PDSCH transmitter transport blocks and provide the PDCCH transmitter transmission parameters related to the transport blocks.

The DL transmitter 2325 may multiplex downlink physical channels and downlink physical signals (including reservation signal) and transmit them via transmission antennas 2331. The UL receiver 2333 may receive multiplexed uplink physical channels and uplink physical signals via receiving antennas 2331 and de-multiplex them. The PUCCH receiver 2335 may provide the higher layer processor 2323 Uplink Control Information (UCI). The PUSCH receiver 2337 may provide the higher layer processor 2323 received transport blocks.

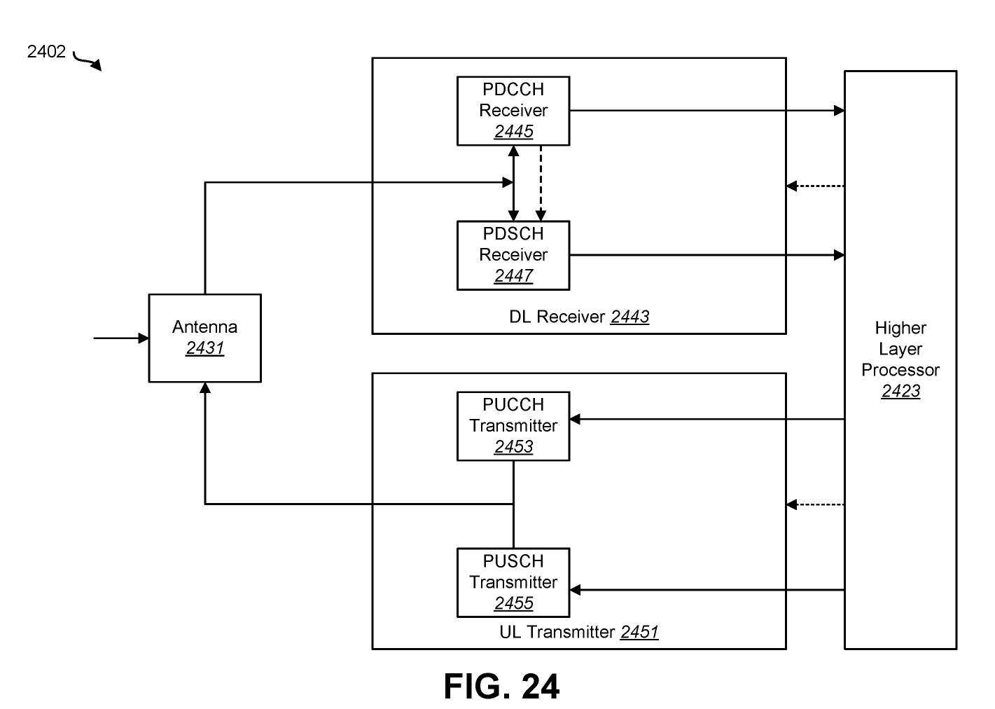

FIG. 24 is a block diagram illustrating one implementation of a UE 2402. The UE 2402 may include a higher layer processor 2423, a UL transmitter 2451, a DL receiver 2443, and one or more antenna 2431. The UL transmitter 2451 may include a PUCCH transmitter 2453 and a PUSCH transmitter 2455. The DL receiver 2443 may include a PDCCH receiver 2445 and a PDSCH receiver 2447.

The higher layer processor 2423 may manage physical layer's behaviors (the UL transmitter's and the DL receiver's behaviors) and provide higher layer parameters to the physical layer. The higher layer processor 2423 may obtain transport blocks from the physical layer. The higher layer processor 2423 may send/acquire higher layer messages such as an RRC message and MAC message to/from a UE's higher layer. The higher layer processor 2423 may provide the PUSCH transmitter transport blocks and provide the PUCCH transmitter 2453 UCI.

The DL receiver 2443 may receive multiplexed downlink physical channels and downlink physical signals via receiving antennas 2431 and de-multiplex them. The PDCCH receiver 2445 may provide the higher layer processor 2423 DCI. The PDSCH receiver 2447 may provide the higher layer processor 2423 received transport blocks.

It should be noted that names of physical channels described herein are examples. The other names such as “NRPDCCH, NRPDSCH, NRPUCCH and NRPUSCH”, “new Generation-(G)PDCCH, GPDSCH, GPUCCH and GPUSCH” or the like can be used.

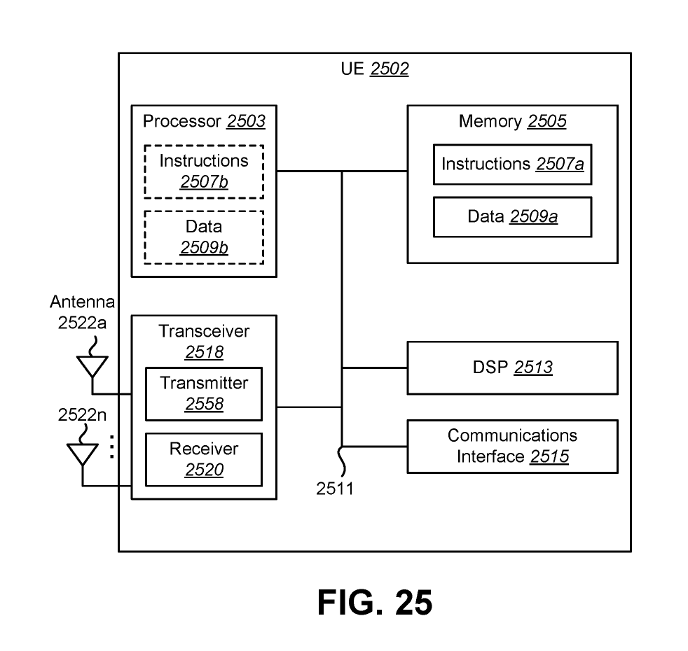

FIG. 25 illustrates various components that may be utilized in a UE 2502. The UE 2502 described in connection with FIG. 25 may be implemented in accordance with the UE 102 described in connection with FIG. 1. The UE 2502 includes a processor 2503 that controls operation of the UE 2502. The processor 2503 may also be referred to as a central processing unit (CPU). Memory 2505, which may include read-only memory (ROM), random access memory (RAM), a combination of the two or any type of device that may store information, provides instructions 2507a and data 2509a to the processor 2503. A portion of the memory 2505 may also include non-volatile random access memory (NVRAM). Instructions 2507b and data 2509b may also reside in the processor 2503. Instructions 2507b and/or data 2509b loaded into the processor 2503 may also include instructions 2507a and/or data 2509a from memory 2505 that were loaded for execution or processing by the processor 2503. The instructions 2507b may be executed by the processor 2503 to implement the methods described above.

The UE 2502 may also include a housing that contains one or more transmitters 2558 and one or more receivers 2520 to allow transmission and reception of data. The transmitter(s) 2558 and receiver(s) 2520 may be combined into one or more transceivers 2518. One or more antennas 2522a-n are attached to the housing and electrically coupled to the transceiver 2518.

The various components of the UE 2502 are coupled together by a bus system 2511, which may include a power bus, a control signal bus and a status signal bus, in addition to a data bus. However, for the sake of clarity, the various buses are illustrated in FIG. 25 as the bus system 2511. The UE 2502 may also include a digital signal processor (DSP) 2513 for use in processing signals. The UE 2502 may also include a communications interface 2515 that provides user access to the functions of the UE 2502. The UE 2502 illustrated in FIG. 25 is a functional block diagram rather than a listing of specific components.

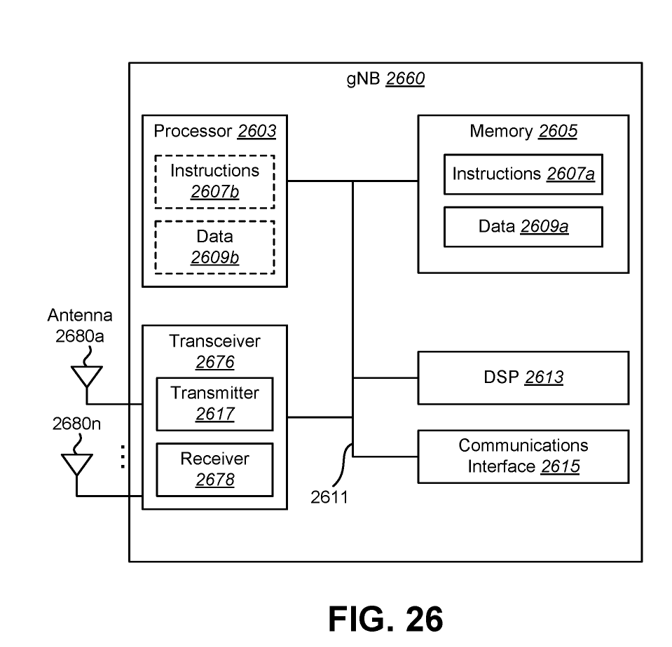

FIG. 26 illustrates various components that may be utilized in a gNB 2660. The gNB 2660 described in connection with FIG. 26 may be implemented in accordance with the gNB 160 described in connection with FIG. 1. The gNB 2660 includes a processor 2603 that controls operation of the gNB 2660. The processor 2603 may also be referred to as a central processing unit (CPU). Memory 2605, which may include read-only memory (ROM), random access memory (RAM), a combination of the two or any type of device that may store information, provides instructions 2607a and data 2609a to the processor 2603. A portion of the memory 2605 may also include non-volatile random access memory (NVRAM). Instructions 2607b and data 2609b may also reside in the processor 2603. Instructions 2607b and/or data 2609b loaded into the processor 2603 may also include instructions 2607a and/or data 2609a from memory 2605 that were loaded for execution or processing by the processor 2603. The instructions 2607b may be executed by the processor 2603 to implement the methods described above.

The gNB 2660 may also include a housing that contains one or more transmitters 2617 and one or more receivers 2678 to allow transmission and reception of data. The transmitter(s) 2617 and receiver(s) 2678 may be combined into one or more transceivers 2676. One or more antennas 2680a-n are attached to the housing and electrically coupled to the transceiver 2676.

The various components of the gNB 2660 are coupled together by a bus system 2611, which may include a power bus, a control signal bus and a status signal bus, in addition to a data bus. However, for the sake of clarity, the various buses are illustrated in FIG. 26 as the bus system 2611. The gNB 2660 may also include a digital signal processor (DSP) 2613 for use in processing signals. The gNB 2660 may also include a communications interface 2615 that provides user access to the functions of the gNB 2660. The gNB 2660 illustrated in FIG. 26 is a functional block diagram rather than a listing of specific components.

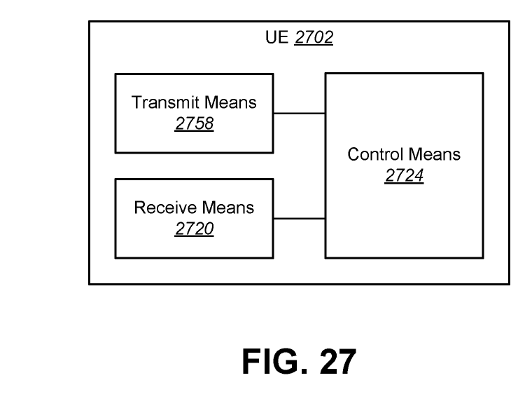

FIG. 27 is a block diagram illustrating one implementation of a UE 2702 in which systems and methods for UE-based handoff (HO) may be implemented. The UE 2702 includes transmit means 2758, receive means 2720 and control means 2724. The transmit means 2758, receive means 2720 and control means 2724 may be configured to perform one or more of the functions described in connection with FIG. 1 above. FIG. 25 above illustrates one example of a concrete apparatus structure of FIG. 27. Other various structures may be implemented to realize one or more of the functions of FIG. 1. For example, a DSP may be realized by software.

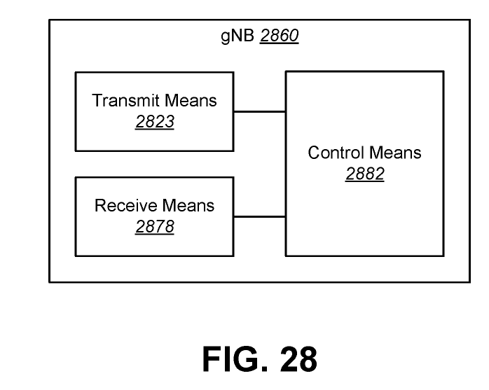

FIG. 28 is a block diagram illustrating one implementation of a gNB 2860 in which systems and methods for UE-based handoff (HO) may be implemented. The gNB 2860 includes transmit means 2817, receive means 2878 and control means 2882. The transmit means 2817, receive means 2878 and control means 2882 may be configured to perform one or more of the functions described in connection with FIG. 1 above. FIG. 26 above illustrates one example of a concrete apparatus structure of FIG. 28. Other various structures may be implemented to realize one or more of the functions of FIG. 1. For example, a DSP may be realized by software.

The term “computer-readable medium” refers to any available medium that can be accessed by a computer or a processor. The term “computer-readable medium,” as used herein, may denote a computer- and/or processor-readable medium that is non-transitory and tangible. By way of example, and not limitation, a computer-readable or processor-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer or processor. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

It should be noted that one or more of the methods described herein may be implemented in and/or performed using hardware. For example, one or more of the methods described herein may be implemented in and/or realized using a chipset, an application-specific integrated circuit (ASIC), a large-scale integrated circuit (LSI) or integrated circuit, etc.

Each of the methods disclosed herein comprises one or more steps or actions for achieving the described method. The method steps and/or actions may be interchanged with one another and/or combined into a single step without departing from the scope of the claims. In other words, unless a specific order of steps or actions is required for proper operation of the method that is being described, the order and/or use of specific steps and/or actions may be modified without departing from the scope of the claims.

It is to be understood that the claims are not limited to the precise configuration and components illustrated above. Various modifications, changes and variations may be made in the arrangement, operation and details of the systems, methods, and apparatus described herein without departing from the scope of the claims.

A program running on the gNB 160 or the UE 102 according to the described systems and methods is a program (a program for causing a computer to operate) that controls a CPU and the like in such a manner as to realize the function according to the described systems and methods. Then, the information that is handled in these apparatuses is temporarily stored in a RAM while being processed. Thereafter, the information is stored in various ROMs or HDDs, and whenever necessary, is read by the CPU to be modified or written. As a recording medium on which the program is stored, among a semiconductor (for example, a ROM, a nonvolatile memory card, and the like), an optical storage medium (for example, a DVD, a MO, a MD, a CD, a BD, and the like), a magnetic storage medium (for example, a magnetic tape, a flexible disk, and the like), and the like, any one may be possible. Furthermore, in some cases, the function according to the described systems and methods described above is realized by running the loaded program, and in addition, the function according to the described systems and methods is realized in conjunction with an operating system or other application programs, based on an instruction from the program.

Furthermore, in a case where the programs are available on the market, the program stored on a portable recording medium can be distributed or the program can be transmitted to a server computer that connects through a network such as the Internet. In this case, a storage device in the server computer also is included. Furthermore, some or all of the gNB 160 and the UE 102 according to the systems and methods described above may be realized as an LSI that is a typical integrated circuit. Each functional block of the gNB 160 and the UE 102 may be individually built into a chip, and some or all functional blocks may be integrated into a chip. Furthermore, a technique of the integrated circuit is not limited to the LSI, and an integrated circuit for the functional block may be realized with a dedicated circuit or a general-purpose processor. Furthermore, if with advances in a semiconductor technology, a technology of an integrated circuit that substitutes for the LSI appears, it is also possible to use an integrated circuit to which the technology applies.

Moreover, each functional block or various features of the base station device and the terminal device used in each of the aforementioned embodiments may be implemented or executed by a circuitry, which is typically an integrated circuit or a plurality of integrated circuits. The circuitry designed to execute the functions described in the present specification may comprise a general-purpose processor, a digital signal processor (DSP), an application specific or general application integrated circuit (ASIC), a field programmable gate array (FPGA), or other programmable logic devices, discrete gates or transistor logic, or a discrete hardware component, or a combination thereof. The general-purpose processor may be a microprocessor, or alternatively, the processor may be a conventional processor, a controller, a microcontroller or a state machine. The general-purpose processor or each circuit described above may be configured by a digital circuit or may be configured by an analogue circuit. Further, when a technology of making into an integrated circuit superseding integrated circuits at the present time appears due to advancement of a semiconductor technology, the integrated circuit by this technology is also able to be used.

What is claimed is:

1. A 5G new radio (NR) user equipment (UE), comprising:
a processor; and
memory in electronic communication with the processor, wherein instructions stored in the memory are executable to:
enable or disable a UE-based handoff (HO) feature in the 5G NR UE.

2. The UE of claim 1, wherein the UE-based HO feature is enabled using RRC signaling during initial access, during HO, during activation of a new service, power-up, area updates, or any other operation.

3. The UE of claim 1, wherein the UE-based HO feature is enabled using NAS signaling during NR 5G attach procedures, during NR 5G Routing Area Updates or during handoff.

4. The UE of claim 1, further comprising de-activation of the UE-based handoff feature upon leaving NR system/capable cells in handoff from NR to LTE, in cell re-selection to LTE or in transition to NR cell where the UE-based HO feature is not supported.

5. The UE of claim 1, wherein new messages and new Information Elements (IEs) in existing UE capability exchange messages indicate support of NR 5G radio capabilities and support of the UE-based handoff feature.

6. The UE of claim 5, wherein a UE-EUTRA-Capability message is used in a dual mode LTE UE that supports NR capabilities while operating in LTE mode, the UE-EUTRA-Capability message including an indication whether the UE supports 5G NR technology, and an indication whether the UE supports the UE-based HO feature.

7. The UE of claim 5, wherein a UE-NRUTRA-Capability message is used with a multi-mode NR UE, wherein the UE-NRUTRA-Capability message includes one or more capability indications, the capability indications including an indication whether the UE supports 5G NR technology, and an indication whether the UE supports UE-based HO feature.

8. The UE of claim 1, wherein information elements (IEs) in SIB3, SIB4, SIB5, or SIB 6 include 5G NR related information to existing LTE messages.

9. The UE of claim 1, wherein UE-based HO is triggered based on preconfigured information, based on information received over the air and stored in a device memory or a Subscriber Identity Module (SIM)-card and/or based on events with specific 5G NR IEs.

10. The UE of claim 1, further comprising receiving UE-based HO trigger events and parameters over the air from a 5G NR base station.

11. The UE of claim 1, further comprising using different combinations of capability reporting, network enablement and/or disablement, and IEs provided by a network and/or stored in the UE to trigger UE-based HO.

12. The UE of claim 1, wherein a RRC message is used to instruct the 5G NR UE with rules and directives on how to make a handoff decision to a selected target cell.

13. The UE of claim 1, further comprising using broadcast information to activate the UE-based handoff, wherein the broadcast information includes an activation flag, a list of neighboring cells with their priorities and system configurations.

14. A 5G new radio (NR) Base Station (gNB), comprising:
a processor; and
memory in electronic communication with the processor, wherein instructions stored in the memory are executable to:
enable or disable a UE-based handoff (HO) feature in a 5G NR user equipment (UE).

15. The gNB of claim 14, wherein the UE-based HO feature is enabled using RRC signaling during initial access, during HO, during activation of a new service, power-up, area updates, or any other operation.

16. The gNB of claim 14, wherein the UE-based HO feature is enabled using NAS signaling during NR 5G attach procedures, during NR 5G Routing Area Updates or during handoff.

17. The gNB of claim 14, further comprising de-activation of the UE-based HO feature upon leaving NR system/capable cells in handoff from NR to LTE, in cell re-selection to LTE or in transition to NR cell where the UE-based handoff feature is not supported.

18. The gNB of claim 14, wherein new messages and new Information Elements (IEs) in existing UE capability exchange messages indicate support of NR 5G radio capabilities and support of the UE-based HO feature.

19. The gNB of claim 18, wherein a UE-EUTRA-Capability message is used in a dual mode LTE UE that supports NR capabilities while operating in LTE mode, the UE-EUTRA-Capability message including an indication whether the UE supports 5G NR technology, and an indication whether the UE supports the UE-based HO feature.

20. The gNB of claim 18, wherein a UE-NRUTRA-Capability message is used with a multi-mode NR UE, wherein the UE-NRUTRA-Capability message includes one or more capability indications, the capability indications including an indication whether the UE supports 5G NR technology, and an indication whether the UE supports UE-based HO feature.

21. The gNB of claim 14, wherein information elements (IEs) in SIB3, SIB4, SIB5, or SIB 6 include 5G NR related information to existing LTE messages.

22. The gNB of claim 14, wherein UE-based HO is triggered based on preconfigured information, based on information received over the air and stored in a device memory or a Subscriber Identity Module (SIM)-card and/or based on events with specific 5G NR IEs.

23. The gNB of claim 14, further comprising sending UE-based HO trigger events and parameters over the air from the 5G NR base station.

24. The gNB of claim 14, further comprising using different combinations of capability reporting, network enablement and/or disablement, and IEs provided by a network and/or stored in the UE to trigger UE-based HO.

25. The gNB of claim 14, wherein a RRC message is used to instruct the 5G NR UE with rules and directives on how to make a handoff decision to a selected target cell.

26. The gNB of claim 14, further comprising using broadcast information to activate the UE-based handoff, wherein the broadcast information includes an activation flag, a list of neighboring cells with their priorities and system configurations.
